(19) United States
(12) Patent Application Publication
(10) Pub. No.: US 2025/0158764 A1
(43) Pub. Date: May 15, 2025

(54) APPARATUS AND METHODS FOR MILLIMETER WAVE COORDINATED MONOSTATIC SENSING

(71) Applicant: HUAWEI TECHNOLOGIES CO., LTD., SHENZHEN (CN)

(72) Inventors: Yan XIN, Kanata (CA); Kwok Shum AU, Kanata (CA); Jung Hoon SUH, Kanata (CA); Osama ABOUL-MAGD, Kanata (CA)

(73) Assignee: HUAWEI TECHNOLOGIES CO., LTD., SHENZHEN (CN)

(21) Appl. No.: 18/593,234

(22) Filed: Mar. 1, 2024

Related U.S. Application Data
(60) Provisional application No. 63/547,935, filed on Nov. 9, 2023.

(51) Int. Cl. H04L 5/00; G01S 13/00; H04W 74/0808

(52) U.S. Cl. CPC H04L 5/0048; H04L 5/0055; H04W 74/0808; G01S 13/003

(57) ABSTRACT

Methods and apparatus for coordinated monostatic sensing are provided, for example in associated with IEEE 802.11 EDMG stations which simultaneously transmit monostatic sensing PPDUs. DMG sensing request frames from a sensing initiator coordinate the sensing responders, and each frame includes a STA ID field, a Num of STAs in Exchange field and a BW field which are used to direct timing and channelization of the sensing PPDUs. In some embodiments, IEEE 802.11 service periods are allocated for transmission operations such as simultaneous monostatic sensing PPDUs on different channels, and related operations such as sensing request frames, sensing response frames, polls, reports, acknowledgments, etc. In some embodiments, IEEE 802.11 contention based access periods are used for the monostatic sensing. Responders determine whether or not they are recipient of a last sensing request frame and operate accordingly to transmit their monostatic sensing PPDU. Determination can be based on the STA ID field.

### CROSS-REFERENCE TO RELATED APPLICATIONS

This application claims priority to U.S. Provisional Patent Application No. 63/547,935, filed Nov. 9, 2023, the contents of which are incorporated herein by reference.

### FIELD OF THE INVENTION

The present disclosure relates to environmental sensing using channel measurements, and particularly to methods and apparatus for performing parallel coordinated monostatic sensing.

### BACKGROUND

Wireless local area network (WLAN) has been widely deployed for commercial and enterprise daily usage worldwide. The IEEE 802.11bf (11bf) standard is intended to amend the existing WLAN standards to add on sensing capabilities through IEEE 802.11-compliant waveforms. Using IEEE 802.11bf, a station (STA) can detect features (e.g., range, velocity, angular, motion, direction, presence or proximity, gesture, etc.) of intended targets (e.g., objects, humans, animals, etc.) in an environment (e.g., house, office, room, vehicle, enterprise, etc.) using received Wi-Fi signals. Draft, adopted and superseded IEEE 802.11 standards are published by the Institute of Electrical and Electronics Engineers (IEEE) standards association, and include the IEEE 802.11ay, IEEE 802.11bf and IEEE 802.11REVme groups of standards documents as cited herein.

In a WLAN sensing system, a station (STA) can play a role as a sensing transmitter that transmits Wi-Fi signals. The same STA or another STA can be used as a sensing receiver that receives the transmitted WLAN signals to measure a radio propagation channel. A sensing receiver may process the measurement and/or forward the channel estimation information to another STA for sensing result analysis. The channel estimate is essentially a fingerprint or signature of the environment in which the WLAN signal is propagating. As elements of the environment change, such as, according to some non-limiting examples, occupant presence, occupant movement, doors and windows opening and closing, or disturbance of the transmitting or receiving antenna, the channel estimate changes along with them. The IEEE 802.11bf standard provides protocols for the collection of channel state information for the purpose of attributing channel state changes to discrete physical events happening in the signal propagating space.

The IEEE 802.11bf standard includes modifications to the medium access control (MAC) and physical layer (PHY) of the existing IEEE 802.11 standards to enhance the WLAN sensing capabilities in the unlicensed bands between 1 GHz and 7.125 GHZ (sub-7 GHZ) and in the 60 GHz band.

Millimeter wave (MMW) WLAN sensing that operates in the 60 GHz band may provide more accurate sensing measurement results due to available larger bandwidths (BWs) compared to relatively lower frequency bands. MMW WLAN sensing types are classified as: monostatic, monostatic with coordination, bi-static, bi-static with coordination, multi-static, and passive sensing. In monostatic sensing or monostatic sensing with coordination, a sensing transmitter is also a sensing receiver. In monostatic sensing with coordination, monostatic sensing measurement is obtained through coordination of multiple monostatic sensing transmitters/receivers. In bistatic sensing or bistatic sensing with coordination, a transmitter and a receiver are in separate stations (STAs). In bistatic sensing with coordination, channel measurement is performed through coordination of multiple bistatic sensing receivers. Multistatic sensing is generalization of a bistatic system to more than two transmitter/receiver pairs.

However, various sensing methodologies as described above are subject to further improvement. Therefore, there is a need for a method, apparatus and systems that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide methods, apparatus and systems for coordinated monostatic sensing, e.g. involving IEEE 802.11 EDMG stations (STAs). Multiple STAs can transmit (and receive) respective monostatic sensing PPDUs concurrently on different channels, following appropriate coordination and setup.

According to embodiments there is provided an apparatus in an IEEE 802.11 EDMG station (STA). The apparatus includes processing electronics and is configured as a sensing responder in a coordinated monostatic sensing operation to. The apparatus is configured to receive a DMG sensing request frame for the coordinated monostatic sensing operation. The DMG sensing request frame includes a STA ID field, a Num of STAs in Exchange field and a BW field. The apparatus is configured to transmit a monostatic sensing PPDU beginning at a transmit time based at least in part on content of the DMG sensing request frame, using a channel determined based on (e.g. non-zero value) content of the BW field. The monostatic sensing PPDU is transmitted concurrently or overlapping in time with one or more other monostatic sensing PPDUs transmitted by one or more other sensing responders in the coordinated monostatic sensing operation. Each of the monostatic sensing PPDU and the other monostatic sensing PPDUs are transmitted on a different respective channel. “ID” refers to an identifier; “Num” refers to number.

In some embodiments, the Num of STAs in Exchange field indicates a number of sensing responders in the coordinated monostatic sensing operation. In such embodiments the apparatus is further configured in the coordinated monostatic sensing operation to: monitor a primary channel to determine a count of one or both of: a plurality of DMG sensing request frames; and a plurality of DMG sensing response frames. The plurality of DMG sensing request frames are transmitted on the primary channel for the coordinated monostatic sensing operation and including said DMG sensing request frame. The plurality of DMG sensing response frames are transmitted on the primary channel in response to the plurality of DMG sensing request frames. The apparatus is further configured to determine the transmit time based at least in part on the count reaching a value contained in the Num of STAs in Exchange field; and transmit the monostatic sensing PPDU beginning at the transmit time. Similarly, the apparatus may be configured to transmit the monostatic sensing PPDU at a transmit time based on a number, of DMG sensing request and/or response frames transmitted on the primary channel for the coordinated monostatic sensing operation, reaching a value contained in the Num of STAs in Exchange field.

In some embodiments, when a value of the STA ID field is less than the value in the Num of STAs in Exchange field, the apparatus is configured to perform a clear channel assessment (CCA) during a time interval of one priority interframe space (PIFS) immediately preceding the transmit time for a channel other than the primary channel, and if CCA indicates the channel is clear, transmit the monostatic sensing PPDU on the channel. When the value of the STA ID field equals the value in the Num of STAs in Exchange field, the apparatus is configured to transmit the monostatic sensing PPDU at or before a time interval of one short interframe space (SIFS) following an end of transmitting the DMG sensing response frame. The monostatic sensing PPDU is transmitted on the primary channel without performing a clear channel assessment (CCA) for the primary channel. In some such embodiments, in the DMG sensing request frame, when the value of the STA ID field equals the value in the Num of STAs in Exchange field, the BW field indicates to transmit the monostatic sensing PPDU on the primary channel. Similarly, in some embodiments, the DMG sensing request frame is received over a primary channel, and when the DMG sensing request frame is a last one of a plurality of DMG sensing request frames transmitted sequentially to a plurality of respective sensing responders in the coordinated monostatic sensing operation, the apparatus is configured to transmit the monostatic sensing PPDU on the primary channel.

In some embodiments, the sensing responder is one of a plurality of sensing responders in the coordinated monostatic sensing operation, and wherein the value in the STA ID field is unique to the sensing responder among the number of sensing responders.

In some embodiments, the apparatus is further configured to store and subsequently utilize a value in the STA ID field for one or both of: an identifier of the sensing responder; and for configuring operations of the coordinated monostatic sensing operation.

In some embodiments, the BW field comprises a plurality of bits each corresponding to a different respective channel, and using the channel determined based on (e.g. non-zero value) content of the BW field comprises using one of the different respective channels which corresponds to one of the plurality bits which is set to one. Accordingly, in some embodiments, a selected bit of the plurality of bits of the BW field is set to ‘one’, while the rest of the bits in the BW field are set to ‘zero.’ The selected bit which is set to ‘one’ is the bit which corresponds to and indicates the channel over which the monostatic sensing PPDU is transmitted, e.g. in the sounding phase. In some embodiments, more than one bit of the BW may be set to ‘one’, to allow for more than one channel usable to transmit the monostatic sensing PPDU. Channels not usable would have their corresponding bits of BW field set to ‘zero.’

In some embodiments, the DMG sensing request frame comprises an IEEE 802.11 TDD beamforming frame having a TDD beamforming frame type subfield set to 3, the STA ID field and the BW field being parts of a TDD beamforming information field for the IEEE 802.11 TDD beamforming frame. The IEEE 802.11 TDD beamforming frame may thus be used as the DMG sensing request frame, when a TDD beamforming frame type subfield set to 3, the STA ID field and the BW field being parts of a TDD beamforming information field for the IEEE 802.11 TDD beamforming frame.

According to embodiments there is provided an apparatus in an IEEE 802.11 EDMG station (STA). The apparatus includes processing electronics and is configured as a sensing initiator in a coordinated monostatic sensing operation. The apparatus is configured to sequentially transmit a plurality of DMG sensing request frames for the coordinated monostatic sensing operation. Each one of the plurality of DMG sensing request frames is transmitted to a different respective one of a plurality of sensing responders and includes a STA ID field and a BW field. The BW field is indicative of a channel to be used by said one of a plurality of sensing responders (to which said one of the plurality of DMG sensing request frames is transmitted, e.g. the sensing responder which the request frame was transmitted to) for transmitting a respective sensing PPDU. Each different one of the DMG sensing request frames holds a different respective STA ID field value which indicates an order of transmission of said one of the DMG sensing request frames, and each different one of the DMG sensing request frames holds a different respective BW field value.

In some such embodiments, the BW field consists of a plurality of bits each corresponding to a different respective channel. Each one of this plurality of bits is indicative of whether or not the corresponding different respective channel is to be used by the aforementioned one of the plurality of sensing responders.

In some embodiments, the BW field consists of a plurality of bits each corresponding to a different respective channel, and at least one of the plurality of bits is set to ‘one’ while remaining ones of the plurality of bits are set to ‘zero.’ The at least one of the plurality of bits which are set to ‘one’ indicate the one of the different respective channels to be used by the aforementioned one of the plurality of sensing responders for transmitting respective monostatic sensing PPDUs.

In some embodiments, for each of the plurality of DMG sensing request frames, the BW field consists of a plurality of bits which are all set to ‘zero,’ indicating that all of the plurality of sensing responders are to transmit respective monostatic sensing PPDUs using a same predetermined one of the respective channels.

According to embodiments there is provided an apparatus in an IEEE 802.11 EDMG station (STA). The apparatus includes processing electronics and is configured as a sensing responder in a coordinated monostatic sensing operation. The apparatus is configured to receive an IEEE 802.11 frame comprising an extended schedule element specifying a plurality of service period (SP) allocations. Each SP allocation indicates a time for a transmission or reception operation involving both the sensing responder and the sensing initiator. The apparatus is configured to transmit and concurrently receive a monostatic sensing PPDU at a time indicated by one of the SP allocations, the monostatic sensing PPDU is transmitted using a channel determined based on (e.g. non-zero value) content of a BW field specified in an EDMG extended schedule element of the IEEE 802.11 frame. The BW field is associated with said one of the SP allocations. The monostatic sensing PPDU is transmitted concurrently or overlapping in time with one or more other monostatic sensing PPDUs transmitted by one or more other sensing responders in the coordinated monostatic sensing operation. The one or more other monostatic sensing PPDUs are transmitted at times indicated by other SP allocations. Each of the monostatic sensing PPDU and the other monostatic sensing PPDUs are transmitted on a different respective channel.

In some embodiments, the apparatus is further configured to receive a sensing request frame from a sensing initiator, the sensing request frame indicative of information for use in performing the coordinated monostatic sensing operation.

In some embodiments, the plurality of SP allocations further includes one or more of: an SP allocation for transmission of a sensing request frame from a sensing initiator to the sensing responder; an SP allocation for transmission of a response to the sensing request frame from the sensing responder to the sensing initiator; an SP allocation for a polling frame, from the sensing initiator to the sensing responder; an SP allocation for a reporting frame, from the sensing responder to the sensing initiator, for reporting a result of the coordinated monostatic sensing operation; and an SP allocation for an acknowledgment frame, from the sensing initiator to the sensing responder, for acknowledging the reporting frame.

In some embodiments, the extended schedule element and the EDMG extended schedule element include, for said one of the plurality of SP allocations, a source AID field and a destination AID field which are both set equal to an identifier of the sensing responder.

In some embodiments, the BW field comprises a plurality of bits each corresponding to a different respective channel, and using the channel determined based on (e.g. non-zero value) content of the BW field includes using one of the different respective channels which corresponds to one of the plurality bits which is set to one.

According to embodiments there is provided an apparatus in an IEEE 802.11 EDMG station (STA). The apparatus includes processing electronics and is configured as a sensing responder in a coordinated monostatic sensing operation. The apparatus is configured, during a transmission opportunity (TXOP) of an IEEE 802.11 contention based access period (CBAP), to receive a DMG sensing request frame for the coordinated monostatic sensing operation, the DMG sensing request frame comprising a STA ID field. The apparatus is configured to transmit a monostatic sensing PPDU beginning at a transmit time based at least in part on content of the DMG sensing request frame, using a channel determined based at least in part on content of the DMG sensing request frame. The monostatic sensing PPDU is one of a plurality of monostatic sensing PPDUs which are transmitted concurrently or overlapping in time with one another by each of a respective plurality of sensing responders, including the sensing responder, in the coordinated monostatic sensing operation. Each of the plurality of monostatic sensing PPDUs is transmitted on a different respective channel.

In some embodiments, each of the plurality of sensing responders receives a respective one of a plurality of DMG sensing request frames during the TXOP, the plurality of DMG sensing request frames being transmitted sequentially on a primary channel. The apparatus is further configured to: determine, based at least in part on a value of the STA ID field and according to a predetermined rule, the transmit time and whether the DMG sensing request frame is a last one of the plurality of DMG sensing request frames transmitted during the TXOP; and when the DMG sensing request frame is the last one of the plurality of DMG sensing request frames transmitted during the TXOP, transmit the monostatic sensing PPDU on the primary channel without performing a clear channel assessment (CCA) for the primary channel.

In some embodiments, the DMG sensing request frame is received from a sensing initiator, and the apparatus is further configured to: transmit a response frame to the sensing initiator in response to the DMG sensing request frame; and transmit the monostatic sensing PPDU at or before a time interval of one short interframe space (SIFS) following an end of transmitting the response frame.

In some embodiments, each of the plurality of sensing responders receives a respective one of a plurality of DMG sensing request frames during the TXOP, the plurality of DMG sensing request frames being transmitted sequentially on a primary channel. In such embodiments the apparatus is further configured to determine, based at least in part on the STA ID field and according to a predetermined rule, whether or not the DMG sensing request frame is a last one of the plurality of DMG sensing request frames transmitted during the TXOP; and when the DMG sensing request frame is not the last one of the plurality of DMG sensing request frames transmitted during the TXOP, perform a clear channel assessment (CCA) during a time interval of one priority interframe space (PIFS) immediately preceding the transmit time for a channel other than the primary channel, and if CCA indicates the channel is clear, transmit the monostatic sensing PPDU on the channel.

In some embodiments, the channel other than the primary channel is determined based on content of a BW field of the DMG sensing request frame. This content may be non-zero value content, e.g. binary ‘ones’ in some embodiments.

In some embodiments, the DMG sensing request frame further comprises a Num of STAs in Exchange field indicating a number of sensing responders in the coordinated monostatic sensing operation. In such embodiments the apparatus is further configured in the coordinated monostatic sensing operation to: monitor a primary channel to determine a count of a plurality of DMG sensing request frames transmitted on the primary channel for the coordinated monostatic sensing operation, including the DMG sensing request frame; and perform the CCA and transmit the monostatic sensing PPDU in response to the count reaching a value contained in the Num of STAs in Exchange field. Similarly, the apparatus may be configured to perform the CCA and transmit the monostatic sensing PPDU following a number, of DMG sensing request frames transmitted on the primary channel for the coordinated monostatic sensing operation, reaching a value contained in the Num of STAs in Exchange field.

In some embodiments, determining whether the DMG sensing request frame is a last one of the plurality of DMG sensing request frames transmitted during the TXOP comprises determining whether the value of the STA ID is equal to a value of a Num of STAs in Exchange field of the DMG sensing request frame.

In some embodiments, each of the plurality of DMG sensing request frames comprises a STA ID field value which indicates an ordering of transmission of the plurality of DMG sensing request frames.

In some embodiments, the CBAP is allocated according to an extended schedule element and pertains to all channels on which the monostatic sensing PPDU and the other monostatic sensing PPDUs are transmitted.

In some embodiments, the DMG sensing request frame further comprises a Num of STAs in Exchange field indicating a number of sensing responders in the coordinated monostatic sensing operation, and the apparatus is further configured in the coordinated monostatic sensing operation to: monitor a primary channel to determine a count of a plurality of DMG sensing request frames transmitted on the primary channel for the coordinated monostatic sensing operation, including the DMG sensing request frame; and transmit the monostatic sensing PPDU in response to the count reaching a value contained in the Num of STAs in Exchange field. Similarly, the apparatus may be configured to transmit the monostatic sensing PPDU following a number, of DMG sensing request frames transmitted on the primary channel for the coordinated monostatic sensing operation, reaching a value contained in the Num of STAs in Exchange field.

According to embodiments there is provided a method, by an apparatus in an IEEE 802.11 EDMG station (STA), the apparatus comprising processing electronics and configured as a sensing responder in a coordinated monostatic sensing operation, the method comprising: receiving a DMG sensing request frame for the coordinated monostatic sensing operation, the DMG sensing request frame comprising a STA ID field, a Num of STAs in Exchange field and a BW field; and transmitting a monostatic sensing PPDU beginning at a transmit time based at least in part on content of the DMG sensing request frame, using a channel determined based on content of the BW field, the monostatic sensing PPDU transmitted concurrently or overlapping in time with one or more other monostatic sensing PPDUs transmitted by one or more other sensing responders in the coordinated monostatic sensing operation, each of the monostatic sensing PPDU and the other monostatic sensing PPDUs being transmitted on a different respective channel.

According to embodiments there is provided a method, by an apparatus in an IEEE 802.11 EDMG station (STA), the apparatus comprising processing electronics and configured as a sensing initiator in a coordinated monostatic sensing operation, the method comprising: sequentially transmitting a plurality of DMG sensing request frames for the coordinated monostatic sensing operation, each one of the plurality of DMG sensing request frames transmitted to a different respective one of a plurality of sensing responders and comprising a STA ID field and a BW field, the BW field indicative of a channel to be used by said one of a plurality of sensing responders (to which said one of the plurality of DMG sensing request frames is transmitted) for transmitting a respective sensing PPDU, wherein each different one of the DMG sensing request frames holds a different respective STA ID field value which indicates an order of transmission of said one of the DMG sensing request frames, and wherein each different one of the DMG sensing request frames holds a different respective BW field value.

According to embodiments there is provided a method, by an apparatus in an IEEE 802.11 EDMG station (STA), the apparatus comprising processing electronics and configured as a sensing responder in a coordinated monostatic sensing operation, the method comprising: receiving an IEEE 802.11 frame comprising an extended schedule element specifying a plurality of service period (SP) allocations, each SP allocation indicating a time for a transmission or reception operation involving the sensing responder; and transmitting and concurrently receive a monostatic sensing PPDU at a time indicated by one of the SP allocations, wherein the monostatic sensing PPDU is transmitted using a channel determined based on content of a BW field specified in an EDMG extended schedule element of the IEEE 802.11 frame, the BW field associated with said one of the SP allocations, the monostatic sensing PPDU transmitted concurrently or overlapping in time with one or more other monostatic sensing PPDUs transmitted by one or more other sensing responders in the coordinated monostatic sensing operation, the one or more other monostatic sensing PPDUs transmitted at times indicated by other SP allocations, each of the monostatic sensing PPDU and the other monostatic sensing PPDUs being transmitted on a different respective channel.

According to embodiments there is provided a method, by an apparatus in an IEEE 802.11 EDMG station (STA), the apparatus comprising processing electronics and configured as a sensing responder in a coordinated monostatic sensing operation, the method comprising: during a transmission opportunity (TXOP) of an IEEE 802.11 contention based access period (CBAP), receiving a DMG sensing request frame for the coordinated monostatic sensing operation, the DMG sensing request frame comprising a STA ID field; and transmitting a monostatic sensing PPDU beginning at a transmit time based at least in part on content of the DMG sensing request frame, using a channel determined based at least in part on content of the DMG sensing request frame, the monostatic sensing PPDU being one of a plurality of monostatic sensing PPDUs which are transmitted concurrently or overlapping in time with one another by each of a respective plurality of sensing responders, including the sensing responder, in the coordinated monostatic sensing operation, each of the plurality of monostatic sensing PPDUs being transmitted on a different respective channel.

In some embodiments, each of the plurality of sensing responders receives a respective one of a plurality of DMG sensing request frames during the TXOP, the plurality of DMG sensing request frames being transmitted sequentially on a primary channel, and the above method further comprises: determining, based at least in part on a value of the STA ID field and according to a predetermined rule, the transmit time and whether the DMG sensing request frame is a last one of the plurality of DMG sensing request frames transmitted during the TXOP; and when the DMG sensing request frame is the last one of the plurality of DMG sensing request frames transmitted during the TXOP, transmitting the monostatic sensing PPDU on the primary channel without performing a clear channel assessment (CCA) for the primary channel.

In some embodiments, each of the plurality of sensing responders receives a respective one of a plurality of DMG sensing request frames during the TXOP, the plurality of DMG sensing request frames being transmitted sequentially on a primary channel, and the above method further comprises: determining, based at least in part on the STA ID field and according to a predetermined rule, whether or not the DMG sensing request frame is a last one of the plurality of DMG sensing request frames transmitted during the TXOP; and when the DMG sensing request frame is not the last one of the plurality of DMG sensing request frames transmitted during the TXOP, performing a clear channel assessment (CCA) during a time interval of one priority interframe space (PIFS) immediately preceding the transmit time for a channel other than the primary channel, and if CCA indicates the channel is clear, transmitting the monostatic sensing PPDU on the channel.

Various other aspects and embodiments of the above methods can be provided, for example commensurate with the corresponding apparatus aspects and embodiments already described above.

According to embodiments there is provided a computer program product comprising a non-transitory computer readable medium having stored thereon programs and instructions which, when executed by a computer, cause an apparatus comprising the computer to perform one or more of the methods as described above.

According to embodiments there is provided a system of multiple apparatuses, such as apparatuses associated with a sensing initiator and one or more sensing responders, where the apparatuses are configured according to one or more of the above embodiments. An apparatus can be a STA, a portion of a STA, a chip, a chipset, a plurality of electronic processing and communication components, etc.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates operations of a sensing initiator and two sensing responders for coordinated monostatic sensing, according to embodiments of the present disclosure.

FIG. 2 illustrates a procedure of coordinated monostatic sensing including conducting monostatic sensing measurements, as well as polling and reporting, in parallel over two sub-channels, according to embodiments of the present disclosure.

FIG. 3 illustrates channelized communication between an access point (AP) and two respective non-AP STAs, according to embodiments of the present disclosure.

FIG. 4 illustrates an electronic device which may operate as sensing initiator or sensing responder, according to embodiments of the present disclosure.

FIG. 5 illustrates another example of an electronic device which may operate as sensing initiator or sensing responder, according to embodiments of the present disclosure.

FIG. 6 illustrates a procedure of coordinated monostatic sensing including conducting monostatic sensing measurements in parallel over a single channel, with sequential polling and reporting over a single channel, according to embodiments of the present disclosure.

FIG. 7 illustrates a procedure of coordinated monostatic sensing including conducting monostatic sensing measurements in parallel over multiple channels, with sequential polling and reporting over a single channel, according to embodiments of the present disclosure.

FIG. 8 illustrates aspects of a DMG sensing request frame, with various fields, which may be involved with embodiments of the present disclosure.

FIG. 9 illustrates aspects of a beacon interval for DMG channel access, which may be involved with embodiments of the present disclosure.

FIG. 10 illustrates aspects of an IEEE 802.11 extended schedule element, which may be involved with embodiments of the present disclosure.

FIG. 11 illustrates aspects of an EDMG extended schedule element, which may be involved with embodiments of the present disclosure.

FIG. 12 illustrates aspects of a channel allocation field in an EDMG extended schedule element when the Scheduling Type subfield in the channel allocation field thereof is set to zero, which may be involved with embodiments of the present disclosure.

FIG. 13 illustrates aspects of a channel allocation field in an EDMG extended schedule element when the Scheduling Type subfield in the channel allocation field thereof is set to one, which may be involved with embodiments of the present disclosure.

FIG. 14 illustrates channel access including PPDU transmissions over two channels in an EDMG scenario, which may be involved with embodiments of the present disclosure.

FIG. 15 illustrates a procedure of coordinated monostatic sensing including conducting monostatic sensing measurements in parallel over multiple channels, including allocation IDs of various communications in accordance with service period (SP) allocations, according to embodiments of the present disclosure.

FIG. 16 illustrates a procedure of coordinated monostatic sensing including conducting monostatic sensing measurements in parallel over multiple channels, using a contention based access period (CBAP) approach, according to embodiments of the present disclosure.

It will be noted that throughout the appended drawings, like features are identified by like reference numerals.

### DETAILED DESCRIPTION

Unless defined otherwise, all technical and scientific terms used herein have the same meaning as commonly understood by one of ordinary skill in the art to which this invention belongs. The numbers and numbers combined with letters correspond to the component labels in all the figures.

As used herein, the term “in parallel” refers to two events, such as transmissions, that occur in parallel in time, for example so as to be simultaneous, or overlapping, or concurrent, at least in part. Two events which occur in parallel (in time) may be substantially exactly simultaneous, so that their beginnings and endings align more or less exactly in time. However, it is also contemplated that two events which occur in parallel (in time) are not necessarily exactly simultaneous. Rather, the two events may instead occur with at least partially overlapping timing with respect to one another, so that at some point in time both events are occurring, but the beginnings, endings, or both, of the two events do not necessarily align in time.

In the various embodiments described below, sensing PPDUs are transmitted in parallel (in time). In several embodiments, frames associated with reporting such as Poll, Report and/or ACK frames are also transmitted in parallel (in time) by more than one device.

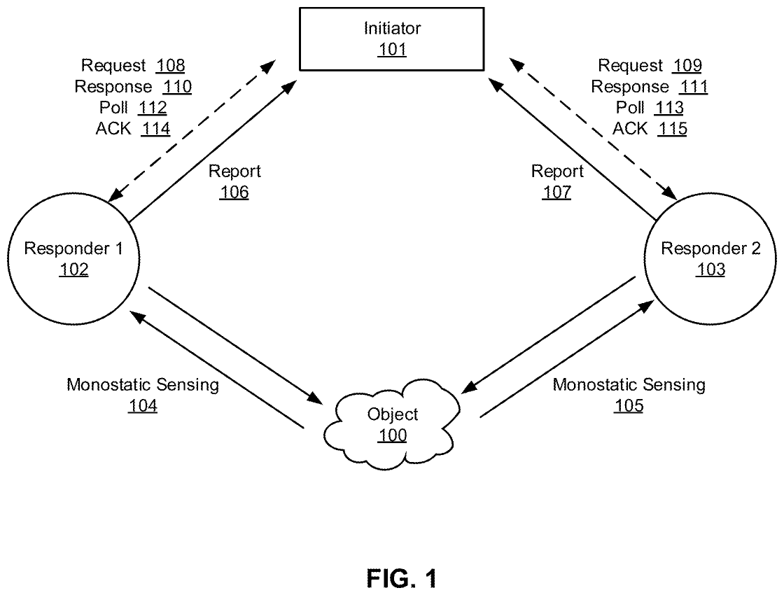

Before describing embodiments of the disclosure in detail, a brief overview of different IEEE 802.11bf sensing modalities in general is provided. Each modality uses wireless signals, e.g. in the form of a sensing PPDU, to sense an object, which may include sensing physical characteristics of the object. Sensing PPDUs may also be referred to as sounding PPDUs. Physical characteristics may include, for example, size, shape, orientation, motion, materials, pose, or the like, or a combination thereof. The sensing PPDU is transmitted wirelessly in compliance with IEEE 802.11 protocols and in a certain frequency band. The object absorbs, reflects, or otherwise interacts with the radio signals carrying the sensing PPDU, such that the received signals are modified. The sensing PPDU is then received and processed to determine the presence and characteristics of such modifications. Based on this, the physical characteristics of the object are estimated. It should be noted that the general sensing setups of FIGS. 1-3 apply to sensing setups according to embodiments of the present disclosure. In monostatic sensing, the responders each obtain measurements of a channel or sub-channel by receiving and processing at least one of the sensing PPDUs.

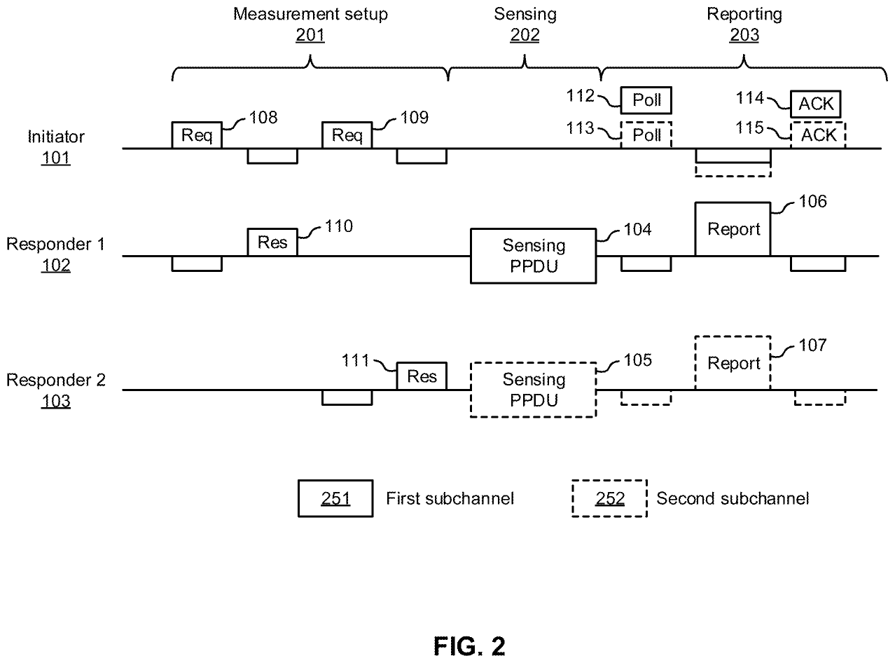

A monostatic sensing device may be a device in which a sensing PPDU transmitter and a sensing PPDU receiver are collocated in the same station (STA). FIG. 1 shows coordinated monostatic sensing with one initiator 101 and two responders 102 and 103, for sensing an object 100. The various messages (which may be frames) are described in more detail with respect to other drawings. Each of the responders 102, 103 performs sensing by transmitting and receiving a respective sensing PPDU upon request from the initiator 101, and responders 102, 103 report to the initiator 101 with the results of the sensing. Receiving a sensing PPDU may involve measuring the characteristics of a designated channel or sub-channel through the use of a receiver. FIG. 1 further illustrates various communications operations, which are described in more detail below with respect to FIG. 2.

FIG. 2 illustrates a procedure of coordinated monostatic sensing with responders 102 and 103 conducting monostatic sensing measurement in parallel over two sub-channels. Request frames 108 and 109 and response frames 110 and 111 are exchanged between initiator 101 and responders 102 and 103 sequentially over sub-channel 251 during a measurement setup phase 201. Here and elsewhere, the (measurement) setup phase can also be called the initial phase or the initiation phase. During the sounding (sensing) phase 202, responder 102 transmits and receives sensing PPDU 104 over a first sub-channel 251. Responder 103 transmits and receives sensing PPDU 105 over a second sub-channel 252 in parallel with sensing PPDU 104. Thus, each responder uses its own respective sub-channel for its own respective sensing PPDU transmission and reception. Here and elsewhere below two different sub-channels may be different with respect to carrier frequency and non-overlapping in the frequency domain. Each sensing responder (102 or 103) may transmit more than one sensing PPDU. For example, a sensing responder (or in other cases, sensing initiator) may transmit a burst of sensing PPDUs for coverage purposes. During a reporting phase 203, measurement reports 106 and 107 are subsequently provided by the responders 102 and 103 to initiator 101 in parallel (in time) over different sub-channels 251 and 252 respectively. Thus, the different responders use different sub-channels for the reporting. Poll (112 and 113), measurement report (106 and 107) and ACK (114 and 115) frames are exchanged between the initiator 101 and the responders 102 and 103 in parallel over sub-channels 251 and 252. One or more of the poll, report and ACK frames may be transmitted in parallel with another respective poll, report or ACK frame corresponding to communication of another initiator-responder pair. This embodiment may provide for more efficient transmissions of measurement reports.

Here and elsewhere herein, receiving a sensing PPDU includes measuring a corresponding channel or sub-channel based on the detected sensing PPDU, as part of obtaining measurements of such channel or sub-channel. This obtaining measurements is done in order to estimate physical characteristics of an object, as described elsewhere above. Measurement reports include information obtained from the responders' measurements (based on the detected/received sensing PPDUs) to the initiator.

Here and elsewhere herein, sub-channels used for sensing are also described as being used for subsequent reporting. This is considered to align well with current IEEE channel assignment operations. However, it is contemplated that the sub-channels used for sensing could potentially be different than those used for reporting.

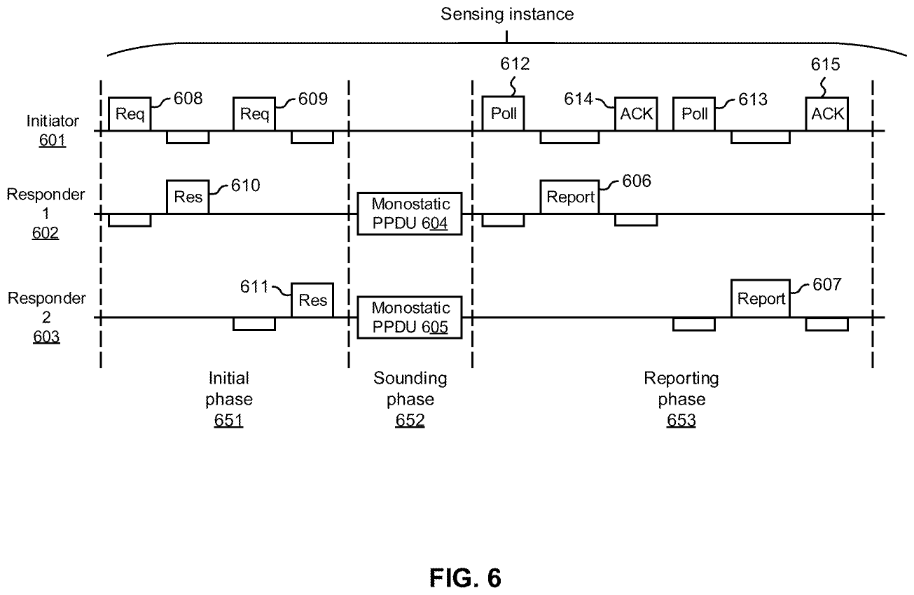

In interpreting FIG. 2, as well as similar drawings such as FIGS. 6, 7, 15 and 16, it is noted that boxes above a line extending from an initiator or responder refer to transmissions, with boxes below the line refer to receptions of corresponding transmissions, and boxes spanning above and below the line refer to combinations of transmission and reception.

Under the IEEE 802.11ay standard, an EDMG STA shall support 4.32 GHz (two contiguous 2.16 GHz sub-channels) for PPDU transmission using EDMG Control mode (MCS 0) and SC mode (MCS 1-5 and 7-10). An EDMG station (STA) may support 2.16+2.16 GHz sub-channels (i.e. two contiguous or non-contiguous sub-channels) for PPDU transmission using EDMG control mode MCS 0, SC mode, and OFDM mode (all MCSs). An EDMG access point (AP) may transmit a DMG Beacon frame using a quasi-omnidirectional antenna pattern. An EDMG AP may allocate an A-BFT over the primary channel and may also allocate an A-BFT over a secondary channel. Therefore, two non-AP STAs may transmit sector sweep (SSW) frames and SSW Feedback frames in parallel in time over the primary and the secondary channel, respectively.

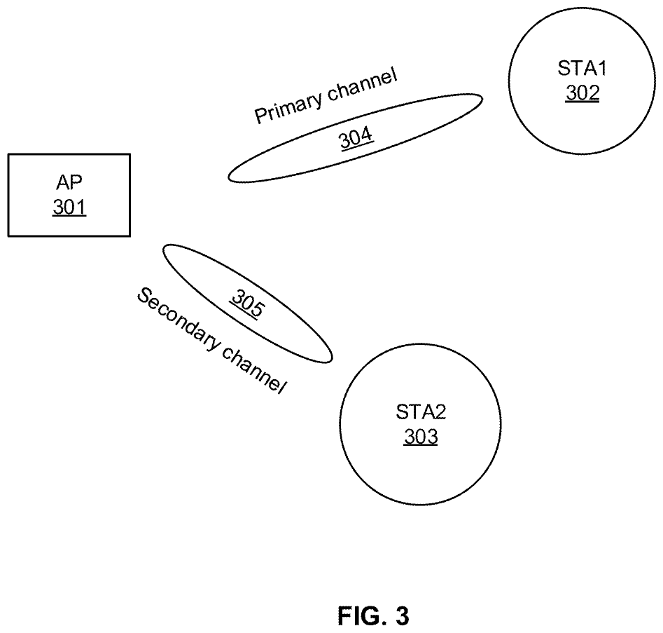

Under the IEEE 802.11ay standard, an access point (AP) 301 may communicate with a non-AP STA1 302 and a non-AP STA2 303 in parallel through a primary channel 304 and a secondary channel 305, respectively, as illustrated in FIG. 3. The IEEE 802.11ay standard specifies a downlink (DL) of a multi-user multiple-input multiple-output (MU-MIMO). Implementation of the MU-MIMO DL feature enables an access point (AP) to transmit N PPDU frames to N users through N spatial streams in parallel. Both multi-sub-channel and DL MU-MIMO features facilitate implementation of efficient and accurate coordinated monostatic sensing as disclosed in the following embodiments. In other words, embodiments of the present disclosure utilize multiple channels (in different frequency sub-channels) for communicating between a sensing initiator and sensing responders. These sub-channels may be described as being different with respect to carrier frequency and non-overlapping in the frequency domain. This use of multiple channels is supported by the IEEE standard as noted above, and allows for parallel transmission of multiple sensing PPDUs, parallel reporting of sensing results, or a combination thereof.

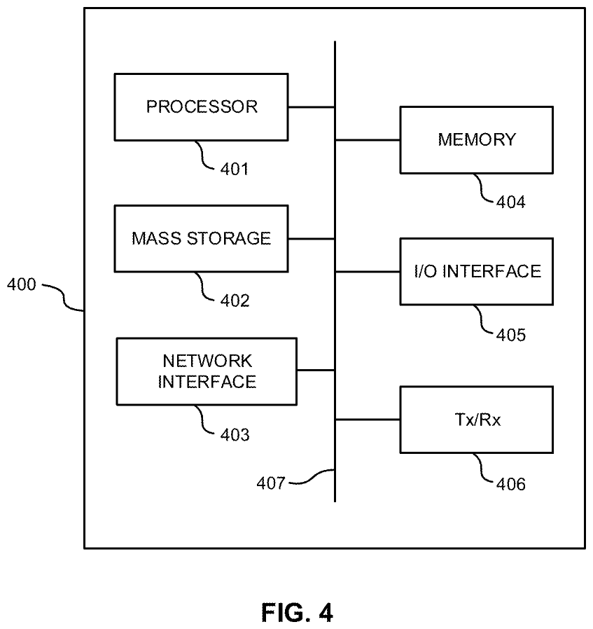

FIG. 4 is a block diagram of an electronic device 400 denoted in the present disclosure as a sensing initiator or a sensing responder. Device 400 may wirelessly communicate with one or more other devices to set up an object sensing measurement, wherein device 400 and the one or more other devices constitute a sensing initiator and one or more sensing responders. Device 400 may be a device in a multi-master system. Device 400 may comprise a computer processor operatively coupled to a computer memory. A computer equipped with network function including wireless transceiver may be configured as device 400. Device 400 may correspond to parts of a computer server, or a network node providing network access (e.g., an IEEE 802.11 access point (AP) or similar device), or a network node accessing a network, e.g. an IEEE 802.11 wireless station (STA). In some embodiments an initiator is an AP or a STA, and each responder is also an AP or a STA. APs and STAs may be wirelessly coupled via a wireless local area network (WLAN) such as an IEEE 802.11 compliant WLAN, with various PPDUs, frames and other communications as described herein being communications following such IEEE 802.11 protocols.

As shown in FIG. 4, device 400 includes a processor 401, such as a Central Processing Unit (CPU) or specialized processors such as a Graphics Processing Unit (GPU) or other such processor unit, memory 404, non-transitory mass storage 402, I/O interface 405, network interface 403, and wireless transceiver 406, all of which are communicatively coupled via bi-directional bus 407. Transceiver 406 includes one or multiple antennas. According to certain embodiments, any or all of the depicted elements may be utilized, or only a subset of the elements. Further, device 400 may contain multiple instances of certain elements, such as multiple processors, memories, or transceivers. Also, elements of the hardware device may be directly coupled to other elements without the bi-directional bus. Additionally or alternatively to a processor and memory, other electronics, such as integrated circuits, may be employed for performing the required logical operations.

Memory 404 may include any type of non-transitory memory such as static random access memory (SRAM), dynamic random access memory (DRAM), synchronous DRAM (SDRAM), read-only memory (ROM), any combination of such, or the like. Mass storage element 402 may include any type of non-transitory storage device, such as a solid state drive, hard disk drive, a magnetic disk drive, an optical disk drive, USB drive, or any computer program product configured to store data and machine executable program code. According to certain embodiments, memory 404 or mass storage 402 may have recorded thereon statements and instructions executable by the processor 401 for performing any of the aforementioned method operations described above.

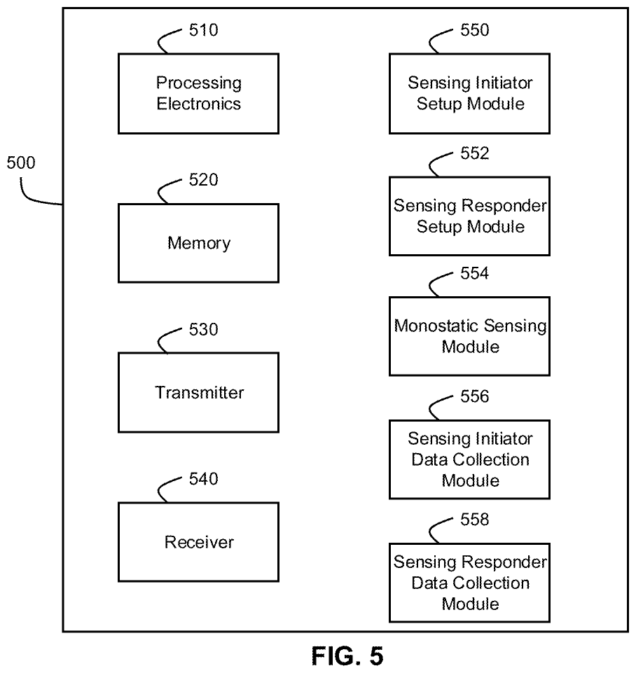

FIG. 5 illustrates an apparatus 500 according to other embodiments of the present disclosure. The apparatus 500 may be provided at least partially using computing and communication components as shown in FIG. 4, for example. The apparatus may be an AP or a non-AP IEEE 802.11 DMG or EDMG STA, for example, and may act as a sensing initiator or sensing responder in a coordinated monostatic sensing operation. The apparatus 500 includes processing electronics 510, such as a computer processor, specialized digital electronic circuitry, analog electronic circuitry, or a combination thereof. The apparatus may include computer memory 520. The memory may store instructions for execution by the computer processor. The memory may further store data such as data to be used in transmissions according to coordinated monostatic sensing operations, or data received according to coordinated monostatic sensing operations. The data may be object sensing data, data for configuring the coordinated monostatic sensing, or a combination thereof. The processing electronics 510 are configured to configure and cause the apparatus to operate in a particular manner as described herein, for example to direct transmission and reception operations, and other associated parts of a coordinated monostatic sensing operation. The apparatus includes a transmitter 530 configured to transmit wireless signals (e.g. forming frames) according to an IEEE 802.11 DMG or EDMG protocol. The apparatus includes a receiver 540 configured to receive wireless signals (e.g. forming frames) according to the IEEE 802.11 DMG or EDMG protocol. Depending on the role of the apparatus, the transmitter 530 may transmit, and the receiver 540 may receive, for example: sensing request frames, sensing response frames, monostatic sensing PPDUs, poll frames, report frames, and acknowledgement frames. The transmitter and receiver may operate on one or more of a plurality of channels. The transmitter 530 and receiver 540 can be integrated together into a transceiver.

The above-described hardware of the apparatus 500 may be viewed as forming one or more functional modules performing operations as described herein. For example, a sensing initiator setup module 550 may configure and send sensing request frames to sensing responders. A sensing responder setup module 552 may receive sensing request frames and configure the apparatus, as a sensing responder, accordingly. These actions may occur in the initial or setup phase. A monostatic sensing module 554 may perform monostatic sensing according to a configuration of the sensing responder setup module in the sensing or sounding phase. A sensing initiator data collection module 556 may poll for, receive, and acknowledge reports from sensing responders. A sensing responder data collection module 558 may send reports in response to polling messages. These actions may occur in the reporting phase. These modules cause device operations as described elsewhere herein. Not all modules need be present in all devices.

One example of MMW WLAN sensing is that a MMW WLAN sensing session is established when a STA and an AP have completed an association and beamforming training.

Another example of MMW WLAN sensing is the coordinated monostatic sensing. FIG. 1 illustrates an example of coordinated monostatic sensing system, which includes: one sensing initiator 101, two sensing responders 102, 103 and the object 100 to sense. FIG. 1 is already described in detail above.

In another example of coordinated monostatic sensing, sensing initiator is a personal basic service set (PBSS) control point (PCP)/access point (AP) station (STA) and multiple sensing responders, non-PCP/AP STAs, are the monostatic transmitter/receiver.

In another example, coordinated monostatic sensing includes three phases: initiation (setup) phase, sounding (sensing) phase and reporting phase.

In another example, coordinated monostatic sensing includes two modes: the serial mode and the parallel mode, in which the monostatic sounding physical layer protocol data unit (PPDUs) for sensing measurement are transmitted serially or simultaneously in time, respectively.

Accordingly, in various embodiments, in the coordinated monostatic sounding parallel mode, multiple monostatic sensing PPDUs from different sensing responders are transmitted concurrently or overlapping in time.

In another example, the procedure of coordinated monostatic sensing in the parallel mode over a single channel is presented in FIG. 6.

During the initial phase 651 of a sensing instance, the sensing request (‘Req’ in the figure) frames 608, 609 are transmitted from the initiator 601 to each of responders 602, 603 sequentially. After receiving a sensing request frame addressed to it, a sensing responder immediately sends a sensing response frame 610, 611 back to the initiator 601. Sensing request and response frames define sets of operational parameters in a sensing instance. During the sounding phase 652, multiple sounding physical layer protocol data units (PPDUs) 604, 605 are transmitted (and received) in parallel, and overlapped in time, by the sensing responders. Different transmit beams are assigned by the initiator to different sensing responders to avoid interference across multiple sensing responders. During the reporting phase 653, the initiator may poll each responder and the corresponding responder may forward the measurement report to the initiator sequentially. This is illustrated using polling frames 612, 613, and reporting frames 606, 607 in response. ACK frames 615, 615 may also be present. However in some embodiments the ACK frames may be omitted. All frames are transmitted over a single channel (for example, the primary channel in the 802.11ay standard). One example of a channel width in 802.11ay is 2.16 GHz. Another example is that in 802.11ay, the maximum number of channels to be bounded is four and in additional to the primary channel, a STA is allowed to use a secondary channel to transmit a frame. Except for the sounding PPDUs 604, 605, all frames are transmitted at different times in the illustrated scenario.

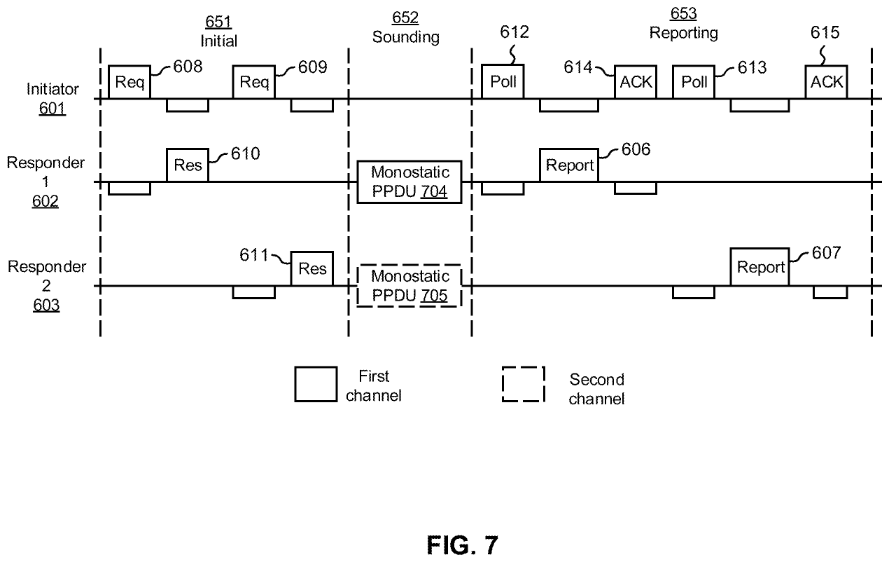

In another relevant scenario, a procedure of coordinated monostatic sensing in the parallel mode over multiple channels is illustrated in FIG. 7.

Similar to the example shown in FIG. 6, in this example Request frames 608, 609 and Poll frames 612, 613 are transmitted from the initiator 601 to the responders 602, 603 sequentially. Response frames 610, 611 and Report frames 606, 607 are transmitted by the responders after receiving the corresponding Request frames and the Poll frames, respectively. An ACK frame 614, 615 is transmitted from the initiator to the responder after the initiator receives the Report frame sent from the correspondent responder. All frames in the initial phase 651 and the reporting phase 653 are transmitted over a first channel (for example, the primary channel in 802.11ay). In the sounding phase 652, multiple monostatic sounding PPDUs 704, 705 are transmitted by multiple responders 602, 603 over different channels (for example, the primary channel and one of the secondary channels in 802.11ay). Each of different channels is assigned to a respective responder. As shown, and in contrast with FIG. 6, the responder 602 transmits (and receives) its monostatic sounding PPDU 704 over a first channel, e.g. the primary channel which is also used for communicating the request, response, polling, report and ACK frames, while the other responder 603 transmits (and receives) its monostatic sounding PPDU 705 over a different channel, e.g. a secondary channel.

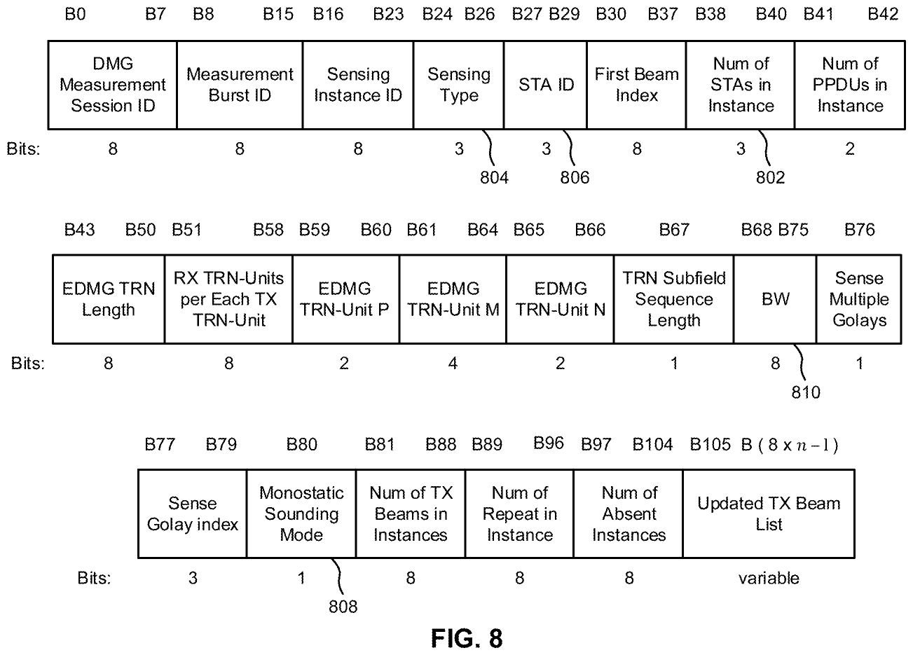

In another example, Directional Multi Gigabit (DMG) Sensing Request frame format is defined in the draft 802.11bf standard as shown in FIG. 8. Note that the Num of STAs in Instance field 802 may be referred to as the Num of STAs in Exchange field in some versions of the draft standard.

The Sensing Type field 804 indicates the type of sensing, i.e., coordinated monostatic, coordinated bistatic, and multistatic sensing, requested by the initiator. The STA ID field 806 indicates the order in which DMG Sensing Request frames are sent in sensing measurement exchanges that use such frame. The Monostatic Sounding Mode field 808 indicates whether the sounding phase of the Coordinated Monostatic sensing instance is performed in the sequential or parallel mode. A value of 1 indicates the sequential mode, a value of 0 indicates the parallel mode. BW field 810 may be an 8-bit map to indicate the bandwidth (BW) to be used in multistatic sensing and may be reserved if the Sensing Type is set to Coordinated Monostatic.

In some cases, BW field 810 may be an 8-bit map to indicate the bandwidth (BW) to be used in multistatic sensing if the Sensing Type is set to multistatic sensing or to indicate which channel to be used for parallel transmission of sensing PPDUs if the Sensing Type is set to Coordinated Monostatic, with the Monostatic Sounding Mode 808 field set to indicate parallel mode (e.g. set to ‘zero’).

In some embodiments, the BW field 810 is reserved if the Sensing Type is set to Coordinated Bistatic or Coordinated Monostatic, with the Monostatic Sounding Mode 808 field set to indicate sequential mode (e.g. set to ‘one’).

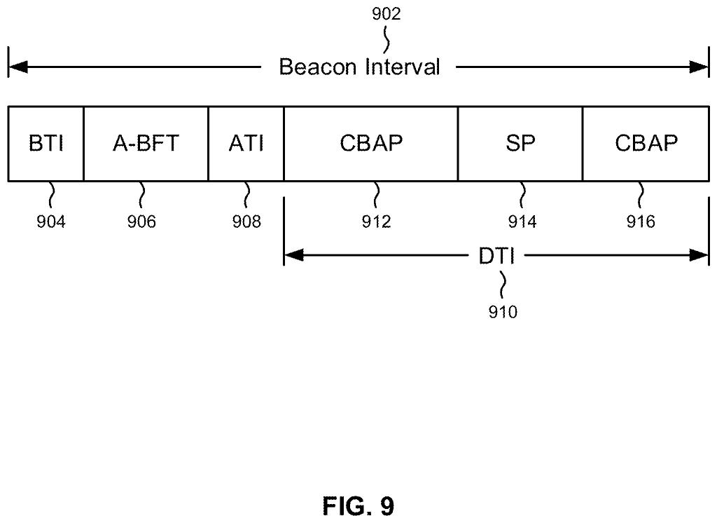

Another embodiment pertains to the DMG channel access process specified in the IEEE 802.11REVme standard (e.g. version 4.0) by optionally including several access periods in order within a beacon interval 902 as presented in FIG. 9. A Beacon frame may include an EDMG Extended Schedule element having the BW field which may be used in embodiments to indicate a channel for transmission of monostatic PPDUs. Further details and context of FIG. 9 can be found in the 802.11REVme standard documents.

FIG. 9 illustrates a BTI (Beacon Transmission Interval) 904, during which one or more DMG Beacon frames are transmitted by a PCP/AP and transmit beamforming training is conducted.

FIG. 9 also illustrates A-BFT (Association Beamforming Training), 906 during which beamforming training is performed with the STA that transmitted a DMG Beacon frame during the preceding BTI.

FIG. 9 also illustrates ATI (announcement transmission interval) 908, which includes a request-response based management access period between the AP or PCP and non-AP and non-PCP STAs.

FIG. 9 also illustrates a DTI (Data Transfer Interval) 910 which may include one or more contention based access period (CBAP) 912, 916 and/or service period (SP) 914. CBAP is one type of access period during which contention based transmission rules is based on distributed coordination function (DCF) and hybrid coordination function (HCF). A STA's AID may be set to the Source AID or the Destination AID of the CBAP. SP is another type of access process in which a period of time is dedicated for frame transmissions between a source STA and a destination STA.

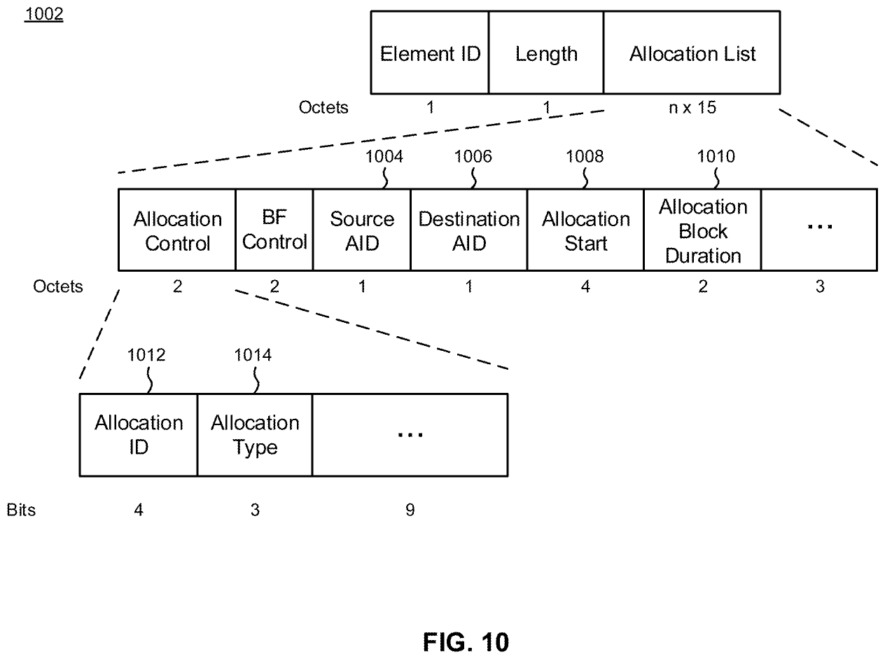

The AP or PCP uses an Extended Schedule element and/or Enhanced Directional Multi Gigabit (EDMG) Extended Schedule element to schedule a CBAP or an SP during the DTI of a beacon interval. The PCP/AP transmits the Extended Schedule element in a DMG Beacon frame and/or an Announce frame over the primary channel. An example Extended Schedule element format is illustrated in FIG. 10. Further details and context of FIG. 10 can be found in the appropriate standard documents, e.g. in IEEE 802.11REVme standards documents, for example in the specification of the Extended Schedule element (e.g. in clause 9.4.2.130) and the EDMG Extended Schedule element (e.g. in clause 9.4.2.267).

As shown in FIG. 10, in the Extended Schedule element 1002, some of the subfields are defined as follows. Source AID 1004 includes AID of source STA in the SP or CBAP. Destination AID 1006 includes AID of destination STA in the SP or CBAP. Allocation Start 1008 contains the lower 4 octets of the timing synchronization function (TSF) at the time the SP or CBAP starts. Allocation Block Duration 1010 indicates the duration, in microseconds, of a time block for which the SP or CBAP allocation is made within a Beacon Interval. Allocation ID 1012, when set to a nonzero value, identifies an airtime allocation from Source AID to Destination AID. AllocationType 1014 defines the channel access mechanism during the allocation, for example, SP allocation or CBAP allocation.

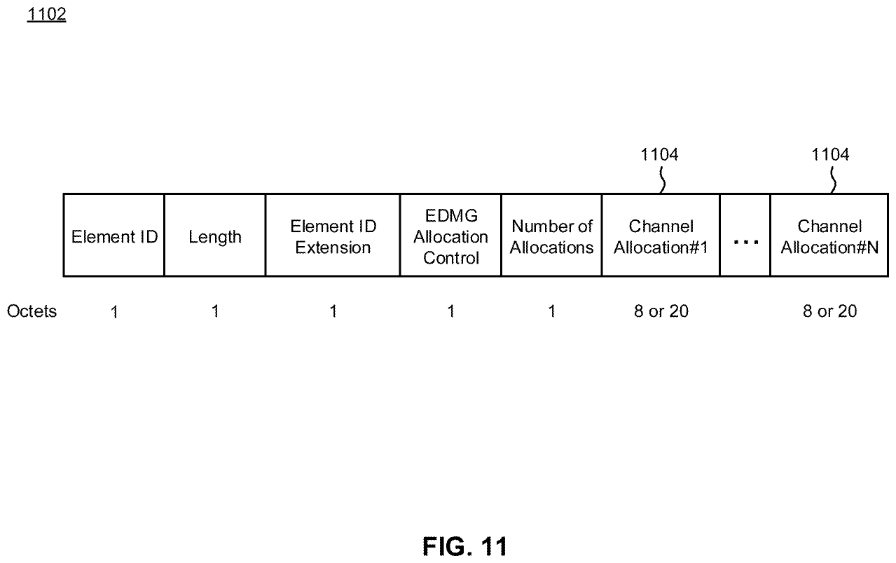

Another relevant scenario pertains to the EDMG channel access process. Different from the DMG channel access, EDMG channel access can operate over the primary channel and/or the secondary channels. In an EDMG BSS, the channel scheduling, including an indication of operating channel(s) in an allocation is defined in the EDMG Extended Schedule element 1102 which is shown in FIG. 11. Further details and context of FIG. 11 can be found e.g. in IEEE 802.11REVme standards documents as cited above. The element 1102 includes one or more instances of a Channel Allocation field 1104.

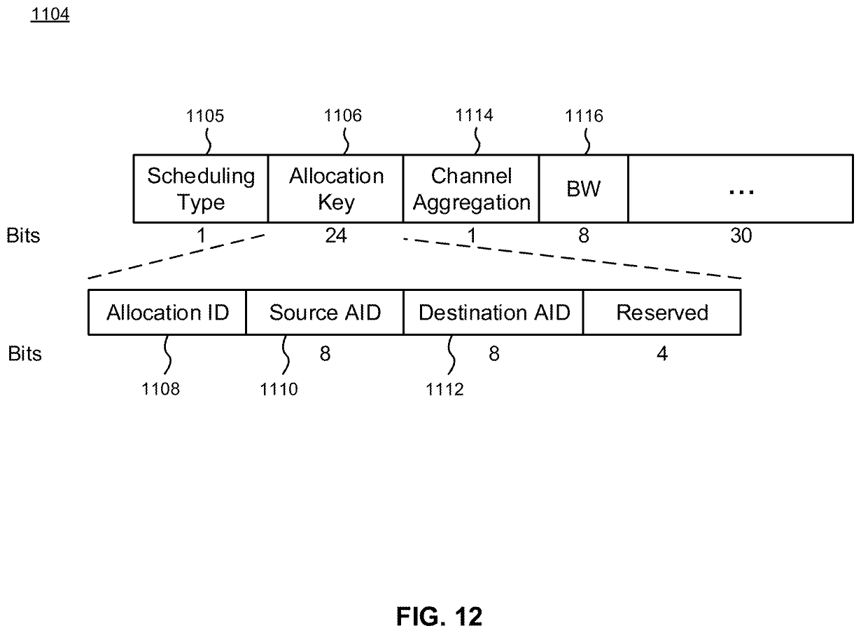

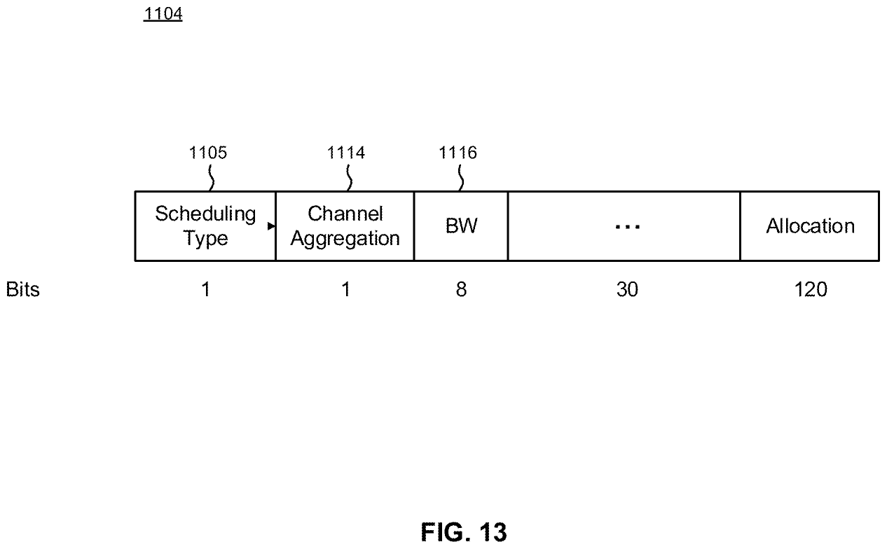

An example of the format of each Channel Allocation field 1104 in the EDMG Extended Schedule element 1102 is shown in FIG. 12 in the case that the Scheduling Type subfield 1105 value in the Channel Allocation field 1104 is set to zero. An example of the format of each Channel Allocation field 1104 in EDMG Extended Schedule element 1102 is shown in in FIG. 13 in the case that the Scheduling Type subfield 1105 value in the Channel Allocation field 1104 is set to one. For example, when the Scheduling Type subfield is set to zero, the Channel Allocation field may contain supplemental allocation information (e.g., bandwidth that the allocation occupies) to the Allocation field in the Extended Schedule element for the same allocation.

An EDMG AP or EDMG PCP may use the EDMG Extended Schedule element 1102 to allocate an SP or a CBAP over channels with different bandwidths possibly combined with the Extended Schedule element. Transmissions within a CBAP or an SP may span the primary channel and the secondary channel(s). The BW of a CBAP or an SP allocation is specified in the BW subfield in Channel Allocation field in the EDMG Extended Schedule element. For partially or fully overlapping allocations, both the source AID and the destination AID of each allocation shall be different from the source AID and destination AID of other overlapping allocation.

In FIG. 12, the Allocation Key subfield 1106 is used to identify the allocation by matching the contents of this subfield with the information obtained from the Extended Schedule element transmitted in the same frame including the EDMG Extended Schedule element 1102. The Allocation ID 1108, Source AID 1110, and Destination AID 1112 subfields are used to identify the allocation already included in the Extended Schedule element.

In both FIG. 12 and FIG. 13, the Channel Aggregation subfield 1114 specifies the type of multi-channel operation, for example, channel bonding or channel aggregation in the allocation. The BW subfield 1116 specifies the channel(s) on which the allocation is scheduled.

In another example, channel access over multiple channels for EDMG STAs are specified. Channel access procedures define a method for a STA on how to access the medium based on a channel access rule. An EDMG STA may maintain physical and virtual carrier sensing (CS) on a primary channel. To perform EDCA channel access in an EDMG BSS, an EDMG STA shall support performing energy detection on each of the supported channels.

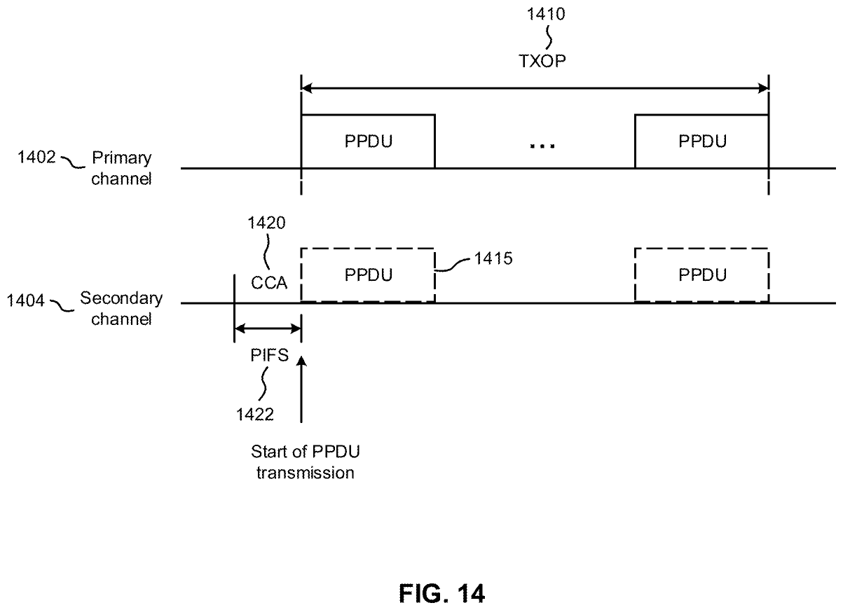

In EDMG, clear channel assessment (CCA) is required to be performed in accessing secondary channels. In more detail for secondary channel access, an EDCA TXOP is obtained and the slot boundaries are determined based solely on the activities of the primary channel. Once an EDCA TXOP has been obtained, channel access over other secondary channels is based on a determination of whether or not a CCA for those secondary channels (e.g. done individually for each secondary channel) indicates that such secondary channel is idle during an interval of a priority interframe space (PIFS) immediately preceding the start of the obtained TXOP, i.e., an interval of one PIFS which ends at the start of PPDU transmission. An example on PPDU transmissions over two channels (for example, the primary channel and the secondary channel) in EDMG is illustrated in FIG. 14.

According to FIG. 14, which shows channel access procedures for PPDU transmissions over two channels in EDMG, the EDCA TXOP 1410 is obtained and pertains to the primary channel 1402. A TXOP may set boundaries for secondary channels when channel bonding or channel aggregation is performed. As illustrated, at least a PPDU 1415 is planned to be transmitted using the secondary channel starting at the beginning of the TXOP. Accordingly, a CCA 1420 is performed in which activity on the secondary channel 1402 is monitored during a time interval 1422 equal to one PIFS. If this monitoring indicates that the secondary channel is clear (no potentially interfering activity), then the transmission of the PPDU 1415 occurs as planned. Otherwise, the transmission is avoided or rescheduled.

As will be understood in view of the above, aspects of the present disclosure are related to techniques involving signaling and procedures to perform coordinated monostatic sensing in the parallel mode over multiple channels for accurate sensing measurement.

An aspect of the present disclosure relates to a method to set up fields carried in a DMG Sensing Request frame, for example as these fields pertain to coordinated monostatic sensing. Setting up the fields may involve specifying values to be encoded into the fields, encoding such values into the fields, or both. Setting up the fields may involve specifying fields to be included in a frame, including such fields in the frame, or both.

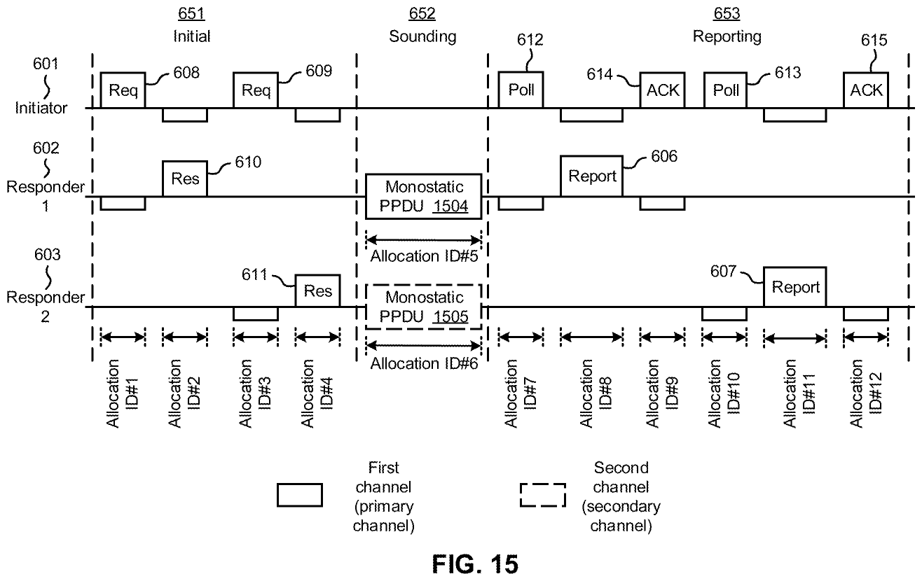

Another aspect of the present disclosure relates to a channel access method for DMG coordinated monostatic sensing in the parallel mode over multiple channels using SP, for example as described with respect to FIG. 15.

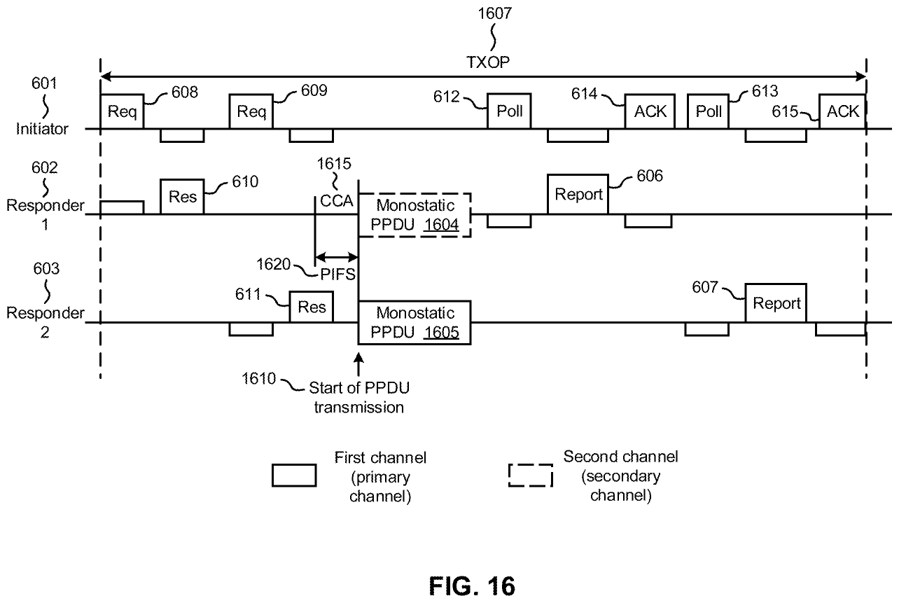

Another aspect of the present disclosure relates to a channel access method for DMG coordinated monostatic sensing in the parallel mode over multiple channels using CBAP, for example as described with respect to FIG. 16.

An aspect of the present disclosure relates to a method to set up the STA ID field 806 in a DMG Sensing Request frame as shown in FIG. 8, which are set by the sensing initiator, in order for the multiple sensing responders in coordinated monostatic sensing to transmit sounding PPDUs which are overlapping in time and which are each transmitted over a different respective channel. Each of the sensing responder STAs in DMG coordinated monostatic sensing in the parallel mode over multiple channels is assigned with a unique STA ID and performs sounding/measurement simultaneously in time over a different respective channel. In various embodiments, the STA ID indicates the order of transmitted DMG Sensing Request frames in sensing measurement exchanges and identifies the responder STA that receives the present frame carrying a specific value in STA ID field. STA ID may also be related to (or indicate) which channel is to be used in the sounding phase by a corresponding responder STA. The responder STA, which correctly receives the present DMG Sensing Request frame, further identifies the value set in the BW field of the present frame to obtain the information on which operating channel to be used in the sounding phase. The responder STA then transmits the monostatic sounding PPDU using the operating channel indicated by the BW field. That is, the responder STA transmits such a sounding (sensing) PPDU using a channel determined based on content of the BW field in the DMG Sensing Request frame.

Another aspect of the present disclosure is the method to set up the BW field in DMG Sensing Request frame for DMG coordinated monostatic sensing in the parallel mode over multiple channels. In DMG Sensing Request frame, the initiator sets the Sensing Type field to Coordinated Monostatic, the Monostatic Sounding Mode field to parallel mode, and the BW field using an 8-bit map to a non-zero value in binary to indicate the operating channel(s) to be used by the sensing Responder along with the identified STA ID to perform sounding and measurement in the sounding phase. One example is that the BW field is set to all ‘zeros’ except one bit set to ‘one’. Another example is that the BW field is set to all ‘zeros’ except more than one bit set to ‘one’. The BW fields carried in different DMG Sensing Request frames sent to respective sensing responders are set to different non-zero values with the respective STA IDs. In various embodiments, these different non-zero values are such that there are no ‘ones’ in the different BW fields which are overlapping at the same bit position. For example, if one BW field has a ‘one’ at the n^{th} bit position, then the other BW fields have a ‘zero’ at the n^{th} bit position. In another example, a binary value of ‘one’ presented in the BW field indicates that the corresponding channel is used for transmission of monostatic PPDU in the sounding phase; a binary value of ‘zero’ presented in the BW field indicates that the corresponding channel is not used for transmission of monostatic PPDU in the sounding phase.

In view of the above, in various embodiments, the BW field as a whole may be set to a non-zero value, with a binary value ‘one’ indicating the channel over which, in the sounding phase, a monostatic PPDU is transmitted. Such an embodiment may be implemented for example if the Sensing Type is coordinated monostatic and the Monostatic Sounding Mode field is set (e.g. to ‘zero’) to indicate parallel mode.

In view of the above, the BW fields carried in different DMG Sensing Request frames may be set to different non-zero values. Each bit of the BW field may indicate whether or not a channel, corresponding to that bit, is to be used by the recipient for sensing. In some cases, only one bit is set (e.g. to ‘one’), indicating one channel to be used. In some cases, more than one bit is set. Setting the BW fields carried in different DMG Sensing Request frames to different non-zero values may have the effect of facilitating transmissions of sounding PPDUs in parallel, concurrently or overlapping in time, by the respective responders. In embodiments, indicating different values of BW fields to different sensing responders will cause those different sensing responders to use different channels to transmit their sensing PPDUs.

The operating channel indicated in or using the BW field may be one of the channels as specified in a BSS Operating Channels field, Primary Channel field, or both, within an EDMG Operation element. The EDMG Operation element may be transmitted by an EDMG AP or an EDMG PCP.

In another aspect of the present disclosure, if in a DMG Sensing Request frame, the Initiator sets the Sensing Type to Coordinated Monostatic, the Monostatic Sounding Mode field to parallel mode, and the BW field to all ‘zeros’, the Responders performs parallel sounding in the Sounding phase in coordinated monostatic sensing over a single channel, for example the primary channel.

Accordingly, in some embodiments, the BW field is set to all ‘zeros’ if the Sensing Type is set to Coordinated Monostatic, and in the sounding phase the Monostatic PPDUs are transmitted solely on the primary channel. This transmission configuration may be indicated by the Monostatic Sounding Mode field being set to indicate parallel mode (e.g. set to ‘zero’).

Another aspect of the present disclosure is related to a channel access method for DMG coordinated monostatic sensing in the parallel mode over multiple channels using SP.

During a service period (SP) allocation, a period of time is dedicated for frame transmission between a source STA and a destination STA, which is scheduled in an Extended Schedule element. SP allocations can be scheduled for transmissions of Sensing Request, Sensing Response, Monostatic sensing PPDU, Poll, Report and ACK frames in DMG coordinated monostatic sensing in the parallel mode over multiple channels with the correspondent Allocation ID, the source AID and the destination AID specified in the Extended Schedule element. In DMG coordinated monostatic sensing in the parallel mode over multiple channels, multiple SP allocations can be scheduled which are overlapping in time (parallel) in the sounding phase. Such SP allocations can be scheduled for multiple Monostatic Sensing Responders that receive the corresponding DMG Sensing Request frames with different non-zero values set in the BW field in EDMG Extended Schedule element.

FIG. 15 illustrates an example of DMG coordinated monostatic sensing in the parallel mode over multiple channels using SP allocation, in which one sensing initiator and two sensing responders are present.

As shown in FIG. 15, during the Initial phase 651 and the Reporting phase 653 in DMG coordinated monostatic sensing in the parallel mode over multiple channels, within each SP Allocation a single frame is transmitted and only over the first channel, for example the primary channel. For example, within SP Allocation with ID #1, a sensing request frame 608 is transmitted from sensing initiator 601 to sensing responder 1 602. SP Allocations with IDs numbered 2 to 4 and 7 to 12 similarly include a single frame transmitted over the first channel. The Source AID or the Destination AID in the Extended Schedule element shown in FIG. 10 and in the EDMG Extended Schedule element shown in FIGS. 11-13 are set to be either the Initiator AID or a Responder AID depending on which STA is the transmitter and which STA is the receiver. For example, a DMG Sensing Request frame 608, 609 is transmitted from the Initiator to a Responder, the Initiator 601 is the transmitter and a Responder (either 602 or 603) is the receiver. Therefore, the Source AID and the Destination AID for this SP allocation are specified to be the Initiator AID and the Responder AID, respectively. Similarly, when a Sensing Report frame is transmitted from a Responder (602 or 603) to the Initiator 601, the Source AID and the Destination AID for the SP allocation are specified to be the Responder AID and the Initiator AID, respectively. In the Initial phase 651 and the Reporting phase 653, a period of time, for example a short interframe space (SIFS), may be specified between a transmission of two frames.

As shown in FIG. 15, during the monostatic sounding phase 652 in DMG coordinated monostatic sensing in the parallel mode over multiple channels using SP allocation, multiple SP allocations with different Allocation IDs are scheduled, which overlap in time and operate over multiple channels. The SP allocations are specified in the Extended Schedule element and/or EDMG Extended Schedule element to respective Responders for transmissions of respective monostatic sensing PPDUs in parallel over respective channels. Both the Source AID and the Destination AID in the Extended Schedule element (shown in FIG. 10) and/or the EDMG Extended Schedule element (shown in FIGS. 11-13) for each SP with a respective Allocation ID in the sounding phase are set to be the correspondent Responder AID. The SP allocations have identifiers ID #5 and ID #6, as illustrated. The SP allocation ID #5 includes the monostatic sensing PPDU 1504 transmitted (and received) by Responder 1 602 over the primary channel, and the Source AID and Destination ID for this SP allocation indicates Responder 1. The concurrent SP allocation ID #6 includes the monostatic sensing PPDU 1505 transmitted (and received) by Responder 2 603 over the secondary channel, and the Source AID and Destination ID for this SP allocation indicates Responder 2.

For each SP allocation, the BW subfield in the Channel Allocation subfield in the EDMG Extended Schedule element (shown in FIGS. 11-13) is set to a different respective non-zero value to specify that different Responders perform sensing sounding/measurement using different channels during the parallel monostatic sounding phase. In DMG coordinated monostatic sensing in the parallel mode with multiple channels, the first channel (for example, the primary channel) indicated in the BW field in the EDMG Extended Schedule element for a first monostatic sensing Responder scheduled within an SP allocation in the sounding phase is set to ‘one’ to indicate that the Monostatic sensing PPDU is transmitted by the first Responder over the first channel (for example, the primary channel); one of the secondary channels indicated in the BW field in the EDMG Extended Schedule element for a second monostatic sensing Responder scheduled within an SP allocation in the sounding phase is set to ‘one’ to indicate that the Monostatic sensing PPDU is transmitted by the second Responder over a second channel (for example, one of secondary channels). Accordingly, for example, a BW field corresponding to an Allocation ID in EDMG Extended Schedule element can specify which channel is to be used for that Allocation ID. Allocation IDs can be assigned to respective SPs for different responders in the sounding phase.

FIG. 15 shows an example in which an SP allocation with Allocation ID #5 is scheduled for Responder 1 with sounding operation over the first channel and an SP allocation with Allocation ID #6 is scheduled for Responder 2 with sounding operation over the second channel.

Another aspect of the present disclosure is a channel access method for DMG coordinated monostatic sensing in the parallel mode over multiple channels using CBAP.

A channel allocation transmission opportunity (TXOP) can apply to DMG coordinated monostatic sensing in the parallel mode over multiple channels, in which DMG coordinated monostatic sensing measurement exchanges are performed within a single TXOP in a CBAP allocation in a DTI scheduled in an Extended Schedule element. FIG. 16 presents an example of DMG coordinated monostatic sensing in the parallel mode over multiple channels using TXOP in which one initiator and two responders are present. A TXOP 1607 is shown, during which channel accesses on two channels occur to perform a coordinated monostatic sensing, including initiation, sounding and reporting phases. The transmissions (frames) sent and received during these phases are comparable to those described above for example with respect to FIG. 15, e.g. including sensing requests 608, 609, responses 610, 611, monostatic (sounding) PPDUs 1604, 1605, polling 612, 613, reports 606, 607, and acknowledgements 614, 615.

It is noted that the CBAP, allocated according to the Extended Schedule element, may pertain to all channels used for transmission of monostatic sensing PPDUs in a coordinated monostatic sensing operation (e.g. both the primary and secondary channels as in FIG. 16). For this reason, all such channels may be used for sensing.

As shown in FIG. 16, in DMG coordinated monostatic sensing in the parallel mode over multiple channels using CBAP, an EDCA TXOP 1607 is obtained based solely on activity of the primary channel (the first channel) and the Request, Response, Poll, Report and ACK frames are transmitted only over the primary channel (the first channel). Each of these frames is transmitted at a different respective time. The Monostatic PPDUs 1604, 1605 are transmitted over the primary channel (the first channel) and one of secondary channels (the second channel), which overlap in time by the different Responders with respective STA IDs. That is, one of the Responders 603 transmits a monostatic sensing PPDU 1605 over the primary channel, and concurrently the other one of the responders 602 transmits a monostatic sensing PPDU 1604 over the secondary channel. Each sensing responder responds to the sensing initiator 601 by sending a DMG Sensing Response frame 610, 611 a SIFS after a corresponding DMG Sensing Request frame 608, 609.

When the initial phase completes, if a DMG Sensing Request frame 608, 609 is correctly received, a sensing responder 602, 603 has the information on when the monostatic PPDU transmission 1604, 1605 starts in the sounding phase. In the sounding phase, sensing responders start to send multiple DMG monostatic sensing PPDUs in parallel in time no later than a SIFS after the last DMG Sensing Response frame. That is, sensing responder 602 sends monostatic PPDU 1604 over the secondary channel and sensing responder 603 sends monostatic PPDU 1605 over the primary channel beginning at start time 1610.

In various embodiments, the Responder assigned with the highest STA ID, which is the Responder 603 receiving the last Request frame 609 in order (e.g. after frame 608 is received), transmits its monostatic sensing PPDU 1605 no later than a SIFS after transmitting the Response frame 611 over the primary channel without performing CCA. That is, this monostatic sensing PPDU 1605 is transmitted by the Responder 603 over the primary channel without performing CCA.

Accordingly, in various embodiments, the Responder that receives the last DMG Sensing Request frame in order, transmits the monostatic sensing PPDU over the primary channel, for example as shown in FIG. 16. In a typical implementation, if a STA transmits a frame on a first channel, it requires a certain period of time for channel switching if the STA transmits a following frame on a second channel. As PIFS may not be long enough for channel switching, in embodiments, the STA (the last responder) that receives the last Request frame (on the primary channel) will transmit the Response frame on the primary channel as well. Also, as SIFS may not be long enough to guarantee the last responder can switch the channel to the second channel to transmit a sensing PPDU, the last responder may be required to transmit a sensing PPDU on the primary channel.

The Responder that receives a DMG Sensing Request frame with an assigned STA ID that is not the highest one, implying that the DMG Sensing Request frame the Responder receives is not the last one in order, may perform CCA on one of the secondary channels (which it is to use to transmit its monostatic sensing PPDU), which is indicated in the BW field in the correspondent DMG Sensing Request frame. This CCA 1615 may be performed during an interval of one priority interframe space (PIFS) 1620 immediately preceding the start 1610 of the monostatic sounding PPDU transmission 1604. As illustrated in FIG. 16, this responder would be the responder 602 which receives the request frame 608. Note that the request frame 608 would specify a STA ID which is lower than a STA ID specified in the later request frame 609. STA IDs may be regarded as identifiers of the responders. A CCA may be required on the secondary channel to satisfy requirements of the IEEE standard, to avoid collisions on the secondary channel, or a combination thereof. If the CCA indicates the channel is clear, the sensing PPDU is transmitted. Otherwise, transmission of the sensing PPDU may be inhibited.

In embodiments, the Responder can determine whether or not the assigned STA ID is the highest one by comparing the STA ID with the Num of STAs in Instance (or Num of STAs in Exchange) field as illustrated in FIG. 8. The Num of STAs in Instance/Exchange field can indicate the total number of Responders, with each Responder receiving a respective DMG Sensing Request frame 608, 609. The STA ID of each DMG Sensing Request frame can indicate whether the DMG Sensing Request frame is the first (STA ID=1), second (STA ID=2), etc. one of the DMG Sensing Request frames. Additionally or alternatively, the Responder can monitor the primary channel to count the DMG Sensing request frames (pertaining to the current sensing operation) transmitted thereon, and compare the count to the content of the Num of STAs in Instance/Exchange field to determine whether or not its assigned STA ID is the highest one, or alternatively whether or not its DMG Sensing Request frame is the last one. Additionally or alternatively to counting such sensing request frames, sensing response frames (also on the primary channel) can be counted via such monitoring. Furthermore, a transmit time for transmitting the sensing PPDU can be determined based on such counting, i.e. based on the count reaching the value in the Num of STAs in Instance/Exchange field. Then, the sensing PPDU can be transmitted at such a determined transmit time. Accordingly, the PPDU transmit time is determined based at least in part on content of the DMG sensing request frame. Similarly, the channel on which the PPDU is transmitted is determined based at least in part on content of the DMG sensing request frame.

For example, according to FIG. 16, the responder 602 may receive sensing request 608 with STA ID=1 and Num of STAs in Instance/Exchange=2 indicated therein, and the responder 603 may receive sensing request 609 with STA ID=2 and Num of STAs in Instance/Exchange=2 indicated therein. Because STA ID is less than Num of STAs in Instance/Exchange in request 608, the responder 602 will determine that it is to use a secondary channel and perform a CCA prior to transmitting the monostatic PPDU 1604. Because STA ID is equal to Num of STAs in Instance/Exchange in request 609, the responder 603 will determine that it is to use the primary channel and not perform a CCA in transmitting the monostatic PPDU 1605. Therefore, the different responders transmit their PPDUs on different respective channels.

It is noted that, in various embodiments, when the STA ID equals the Num of STAs in Instance/Exchange field in the sensing request, the BW field in that sensing request may also indicate that the responder is to transmit the sensing PPDU on the primary channel. Thus, the BW field indication may accord with the convention that the last responder to receive a request is to use the primary channel for sensing. It is also noted that values of STA ID fields of different sensing request frames are generally different, and each may be unique to the sensing responder to which the request frame is transmitted (where different responders have different assigned STA IDs.) In other words, each sensing request frame, sent to a different responder, holds a different respective STA ID field value. This value indicates (or at least corresponds to) the order of transmission of the sensing request frames, e.g. whether the sensing request frame is the first, second, etc. one of the request frames transmitted for the current sensing operation.

The sensing request frames are sent sequentially, i.e. at different times. It is noted that whether or not a sensing request is (or is not) a last sensing request can be determined based on comparing the STA ID to the Num of STAs in Instance/Exchange field, or by monitoring for and counting the sensing requests and comparing the count to the value in the Num of STAs in Instance/Exchange field, or a combination thereof. When the count (or the STA ID) equals the value in the Num of STAs in Instance/Exchange field, the sensing request frame can be inferred to be the last such sensing request frame. Again, the channel for transmitting the sensing PPDU, the transmit time for the sensing PPDU, and whether or not a CCA is performed before transmitting the sensing PPDU, may be determined based on whether or not a received sensing request is or is not a last sensing request.

In various embodiments, a sensing responder may have its STA ID assigned via such sensing request frames. That is, a sensing responder, receiving a sensing request frame, may store the STA ID value indicated therein. The STA ID value may subsequently be utilized for example as an ID of the sensing responder, for configuring the sensing operation, etc.

In the reporting phase, the first Poll frame 612 is transmitted from the Initiator 601 to a Responder 602 over the primary channel (the first channel) no later than a SIFS after the Monostatic PPDU 1604 transmitted over the primary channel. Each sensing responder responds to the sensing initiator with a DMG Sensing Measurement Report frame 606, 607, a SIFS after the corresponding DMG Sensing Poll frame 612, 613. The Sensing Measurement Report frames are transmitted over the primary channel (the first channel). An ACK frame 614, 615 may be transmitted from the Initiator 601 to the Responder 602, 603, a SIFS after the DMG Sensing Measurement Report frame over the primary channel (the first channel).

In some embodiments, the Initiator first polls the Responder that receives the last DMG Sensing Request frame in order over the primary channel.

The present disclosure encompasses various embodiments, including not only method embodiments, but also other embodiments such as apparatus embodiments and embodiments related to non-transitory computer readable storage media. Method embodiments, for example, may also or instead be implemented in apparatus, system, and/or computer program product embodiments. Computer readable media could store programming or instructions to perform any of various methods consistent with the present disclosure. Embodiments may incorporate, individually or in combinations, the features disclosed herein.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, mobile device, IEEE STA, IEEE AP, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

### ACRONYMS, ABBREVIATIONS, AND INITIALISMS

| | Acronym/Abbreviation/ |
|---|---|
| Full Name | Initialism |
| Association Beamforming Training | A-BFT |
| Association identifier | AID |
| Access point | AP |
| Announcement transmission interval | ATI |
| Bandwidth | BW |
| Basic service set | BSS |
| Beacon Transmission Interval | BTI |
| Contention based access period | CBAP |
| Carrier sensing | CS |
| Distributed coordination function | DCF |
| Directional Multi Gigabit | DMG |
| Enhanced distributed channel access | EDCA |
| Enhanced Directional Multi Gigabit | EDMG |
| Local Area Network | LAN |
| Medium Access Control Layer | MAC |
| Millimeter wave | MMW |
| Orthogonal frequency division multiplexing | OFDM |
| Personal basic service set (PBSS) control point | PCP |
| Physical Layer | PHY |
| Priority interframe space | PIFS |
| Physical layer protocol data unit | PPDU |
| Short interframe space | SIFS |
| Service period | SP |
| Station | STA |
| Transmission opportunity | TXOP |
| Wireless LAN | WLAN |

What is claimed is:

1. An apparatus in an IEEE 802.11 EDMG station (STA), the apparatus comprising processing electronics and configured as a sensing responder in a coordinated monostatic sensing operation to:
receive a DMG sensing request frame for the coordinated monostatic sensing operation, the DMG sensing request frame comprising a STA ID field, a Num of STAs in Exchange field and a BW field; and
transmit a monostatic sensing PPDU beginning at a transmit time based at least in part on content of the DMG sensing request frame, using a channel determined based on content of the BW field, the monostatic sensing PPDU transmitted concurrently or overlapping in time with one or more other monostatic sensing PPDUs transmitted by one or more other sensing responders in the coordinated monostatic sensing operation, each of the monostatic sensing PPDU and the other monostatic sensing PPDUs being transmitted on a different respective channel.

2. The apparatus of claim 1, wherein the Num of STAs in Exchange field indicates a number of sensing responders in the coordinated monostatic sensing operation, the apparatus further configured in the coordinated monostatic sensing operation to:
monitor a primary channel to determine a count of one or both of: a plurality of DMG sensing request frames; and a plurality of DMG sensing response frames, the plurality of DMG sensing request frames transmitted on the primary channel for the coordinated monostatic sensing operation and including said DMG sensing request frame, the plurality of DMG sensing response frames transmitted on the primary channel in response to the DMG sensing request frames, the plurality of DMG sensing response frames transmitted on the primary channel in response to the plurality of DMG sensing request frames;
determine the transmit time based at least in part on the count reaching a value contained in the Num of STAs in Exchange field; and
transmit the monostatic sensing PPDU beginning at the transmit time.

3. The apparatus of claim 2, further configured to:
when a value of the STA ID field is less than the value in the Num of STAs in Exchange field, perform a clear channel assessment (CCA) during a time interval of one priority interframe space (PIFS) immediately preceding the transmit time for a channel other than the primary channel, and if CCA indicates the channel is clear, transmit the monostatic sensing PPDU on the channel; and
when the value of the STA ID field equals the value in the Num of STAs in Exchange field, transmit the monostatic sensing PPDU at or before a time interval of one short interframe space (SIFS) following an end of transmitting the DMG sensing response frame, the monostatic sensing PPDU being transmitted on the primary channel without performing a clear channel assessment (CCA) for the primary channel.

4. The apparatus of claim 3, wherein, in the DMG sensing request frame, when the value of the STA ID field equals the value in the Num of STAs in Exchange field, the BW field indicates to transmit the monostatic sensing PPDU on the primary channel.

5. The apparatus of claim 1, wherein the DMG sensing request frame is received over a primary channel, and wherein, when the DMG sensing request frame is a last one of a plurality of DMG sensing request frames transmitted sequentially to a plurality of respective sensing responders in the coordinated monostatic sensing operation, the apparatus is configured to transmit the monostatic sensing PPDU on the primary channel.

6. The apparatus of claim 1, wherein the sensing responder is one of a plurality of sensing responders in the coordinated monostatic sensing operation, and wherein the value in the STA ID field is unique to the sensing responder among the number of sensing responders.

7. The apparatus of claim 1, further configured to store and subsequently utilize a value in the STA ID field for one or both of: an identifier of the sensing responder; and for configuring operations of the coordinated monostatic sensing operation.

8. The apparatus of claim 1, wherein the BW field comprises a plurality of bits each corresponding to a different respective channel, and wherein using the channel determined based on content of the BW field comprises using one of the different respective channels which corresponds to one of the plurality bits which is set to one.

9. The apparatus of claim 1, wherein the IEEE 802.11 TDD beamforming frame is used as the DMG sensing request frame, when a TDD beamforming frame type subfield set to 3, the STA ID field and the BW field being parts of a TDD beamforming information field for the IEEE 802.11 TDD beamforming frame.

10. An apparatus in an IEEE 802.11 EDMG station (STA), the apparatus comprising processing electronics and configured as a sensing initiator in a coordinated monostatic sensing operation to:
sequentially transmit a plurality of DMG sensing request frames for the coordinated monostatic sensing operation, each one of the plurality of DMG sensing request frames transmitted to a different respective one of a plurality of sensing responders and comprising a STA ID field and a BW field, the BW field indicative of a channel to be used by said one of a plurality of sensing responders for transmitting a respective sensing PPDU,
wherein each different one of the DMG sensing request frames holds a different respective STA ID field value which indicates an order of transmission of said one of the DMG sensing request frames, and
wherein each different one of the DMG sensing request frames holds a different respective BW field value.

11. The apparatus of claim 10, wherein the BW field consists of a plurality of bits each corresponding to a different respective channel, each one of the plurality of bits indicative of whether or not the corresponding different respective channel is to be used by said one of the plurality of sensing responders.

12. The apparatus of claim 10, wherein the BW field consists of a plurality of bits each corresponding to a different respective channel, and wherein at least one of the plurality of bits is set to ‘one’ while remaining ones of the plurality of bits are set to ‘zero,’ the at least one of the plurality of bits which are set to ‘one’ indicating said one of the different respective channels to be used by said one of the plurality of sensing responders for transmitting respective monostatic sensing PPDUs.

13. The apparatus of claim 10, wherein, for each of the plurality of DMG sensing request frames, the BW field consists of a plurality of bits which are all set to ‘zero,’ indicating that all of the plurality of sensing responders are to transmit respective monostatic sensing PPDUs using a same predetermined one of the respective channels.

14. An apparatus in an IEEE 802.11 EDMG station (STA), the apparatus comprising processing electronics and configured as a sensing responder in a coordinated monostatic sensing operation to:
during a transmission opportunity (TXOP) of an IEEE 802.11 contention based access period (CBAP), receive a DMG sensing request frame for the coordinated monostatic sensing operation, the DMG sensing request frame comprising a STA ID field and a BW field; and
transmit a monostatic sensing PPDU beginning at a transmit time based at least in least in part on content of the DMG sensing part on content of the DMG sensing request frame, using a channel determined based at request frame, the monostatic sensing PPDU being one of a plurality of monostatic sensing PPDUs which are transmitted concurrently or overlapping in time with one another by each of a respective plurality of sensing responders, including the sensing responder, in the coordinated monostatic sensing operation, each of the plurality of monostatic sensing PPDUs being transmitted on a different respective channel.

15. The apparatus of claim 14, wherein each of the plurality of sensing responders receives a respective one of a plurality of DMG sensing request frames during the TXOP, the plurality of DMG sensing request frames being transmitted sequentially on a primary channel, the apparatus further configured to:
determine, based at least in part on a value of the STA ID field and according to a predetermined rule, the transmit time and whether the DMG sensing request frame is a last one of the plurality of DMG sensing request frames transmitted during the TXOP; and
when the DMG sensing request frame is the last one of the plurality of DMG sensing request frames transmitted during the TXOP, transmit the monostatic sensing PPDU on the primary channel without performing a clear channel assessment (CCA) for the primary channel.

16. The apparatus of claim 14, wherein the DMG sensing request frame is received from a sensing initiator, the apparatus further configured to:
transmit a response frame to the sensing initiator in response to the DMG sensing request frame; and
transmit the monostatic sensing PPDU at or before a time interval of one short interframe space (SIFS) following an end of transmitting the response frame.

17. The apparatus of claim 14, wherein each of the plurality of sensing responders receives a respective one of a plurality of DMG sensing request frames during the TXOP, the plurality of DMG sensing request frames being transmitted sequentially on a primary channel, the apparatus further configured to:
determine, based at least in part on the STA ID field and according to a predetermined rule, whether or not the DMG sensing request frame is a last one of the plurality of DMG sensing request frames transmitted during the TXOP; and
when the DMG sensing request frame is not the last one of the plurality of DMG sensing request frames transmitted during the TXOP, perform a clear channel assessment (CCA) during a time interval of one priority interframe space (PIFS) immediately preceding the transmit time for a channel other than the primary channel, and if CCA indicates the channel is clear, transmit the monostatic sensing PPDU on the channel.

18. The apparatus of claim 17, wherein the channel other than the primary channel is determined based on content of a BW field of the DMG sensing request frame.

19. The apparatus of claim 17, wherein the DMG sensing request frame further comprises a Num of STAs in Exchange field indicating a number of sensing responders in the coordinated monostatic sensing operation, the apparatus further configured in the coordinated monostatic sensing operation to:
monitor a primary channel to determine a count of a plurality of DMG sensing request frames transmitted on the primary channel for the coordinated monostatic sensing operation, including the DMG sensing request frame; and
perform the CCA and transmit the monostatic sensing PPDU in response to the count reaching a value contained in the Num of STAs in Exchange field.

20. The apparatus of claim 15, wherein determining whether the DMG sensing request frame is a last one of the plurality of DMG sensing request frames transmitted during the TXOP comprises determining whether the value of the STA ID is equal to a value of a Num of STAs in Exchange field of the DMG sensing request frame.

21. The apparatus of claim 20, wherein each of the plurality of DMG sensing request frames comprises a STA ID field value which indicates an ordering of transmission of the plurality of DMG sensing request frames.

22. The apparatus of claim 14, wherein the CBAP is allocated according to an extended schedule element and pertains to all channels on which the monostatic sensing PPDU and the other monostatic sensing PPDUs are transmitted.

23. The apparatus of claim 14, wherein the DMG sensing request frame further comprises a Num of STAs in Exchange field indicating a number of sensing responders in the coordinated monostatic sensing operation, the apparatus further configured in the coordinated monostatic sensing operation to transmit the monostatic sensing PPDU following a number, of DMG sensing request frames transmitted on the primary channel for the coordinated monostatic sensing operation, reaching a value contained in the Num of STAs in Exchange field.

24. A method, by an apparatus in an IEEE 802.11 EDMG station (STA), the apparatus comprising processing electronics and configured as a sensing responder in a coordinated monostatic sensing operation, the method comprising:
receiving a DMG sensing request frame for the coordinated monostatic sensing operation, the DMG sensing request frame comprising a STA ID field, a Num of STAs in Exchange field and a BW field; and
transmitting a monostatic sensing PPDU beginning at a transmit time based at least in part on content of the DMG sensing request frame, using a channel determined based on content of the BW field, the monostatic sensing PPDU transmitted concurrently or overlapping in time with one or more other monostatic sensing PPDUs transmitted by one or more other sensing responders in the coordinated monostatic sensing operation, each of the monostatic sensing PPDU and the other monostatic sensing PPDUs being transmitted on a different respective channel.

25. A method, by an apparatus in an IEEE 802.11 EDMG station (STA), the apparatus comprising processing electronics and configured as a sensing initiator in a coordinated monostatic sensing operation, the method comprising:
sequentially transmitting a plurality of DMG sensing request frames for the coordinated monostatic sensing operation, each one of the plurality of DMG sensing request frames transmitted to a different respective one of a plurality of sensing responders and comprising a STA ID field and a BW field, the BW field indicative of a channel to be used by said one of a plurality of sensing responders for transmitting a respective sensing PPDU,
wherein each different one of the DMG sensing request frames holds a different respective STA ID field value which indicates an order of transmission of said one of the DMG sensing request frames, and
wherein each different one of the DMG sensing request frames holds a different respective BW field value.

26. A method, by an apparatus in an IEEE 802.11 EDMG station (STA), the apparatus comprising processing electronics and configured as a sensing responder in a coordinated monostatic sensing operation, the method comprising:
during a transmission opportunity (TXOP) of an IEEE 802.11 contention based access period (CBAP), receiving a DMG sensing request frame for the coordinated monostatic sensing operation, the DMG sensing request frame comprising a STA ID field; and
transmitting a monostatic sensing PPDU beginning at a transmit time based at least in part on content of the DMG sensing request frame, using a channel determined based at least in part on content of the DMG sensing request frame, the monostatic sensing PPDU being one of a plurality of monostatic sensing PPDUs which are transmitted concurrently or overlapping in time with one another by each of a respective plurality of sensing responders, including the sensing responder, in the coordinated monostatic sensing operation, each of the plurality of monostatic sensing PPDUs being transmitted on a different respective channel.

27. The method of claim 26, wherein each of the plurality of sensing responders receives a respective one of a plurality of DMG sensing request frames during the TXOP, the plurality of DMG sensing request frames being transmitted sequentially on a primary channel, the method further comprising:
determining, based at least in part on a value of the STA ID field and according to a predetermined rule, the transmit time and whether the DMG sensing request frame is a last one of the plurality of DMG sensing request frames transmitted during the TXOP; and
when the DMG sensing request frame is the last one of the plurality of DMG sensing request frames transmitted during the TXOP, transmitting the monostatic sensing PPDU on the primary channel without performing a clear channel assessment (CCA) for the primary channel.

28. The method of claim 26, wherein each of the plurality of sensing responders receives a respective one of a plurality of DMG sensing request frames during the TXOP, the plurality of DMG sensing request frames being transmitted sequentially on a primary channel, the method further comprising:
determining, based at least in part on the STA ID field and according to a predetermined rule, whether or not the DMG sensing request frame is a last one of the plurality of DMG sensing request frames transmitted during the TXOP; and
when the DMG sensing request frame is not the last one of the plurality of DMG sensing request frames transmitted during the TXOP, performing a clear channel assessment (CCA) during a time interval of one priority interframe space (PIFS) immediately preceding the transmit time for a channel other than the primary channel, and if CCA indicates the channel is clear, transmitting the monostatic sensing PPDU on the channel.
